(19) United States
(12) Patent Application Publication
(10) Pub. No.: US 2026/0355708 A1
(43) Pub. Date: Nov. 12, 2026

(54) REAL TIME MONITORING OF POLYMER MIXTURES USING REFRACTOMETRY

(71) Applicant: KEMIRA OYJ, HELSINKI (FI)

(72) Inventors: Mehrdad HESAMPOUR, Espoo (FI); Sampsa GREUS, Espoo (FI)

(21) Appl. No.: 19/134,770

(22) PCT Filed: Dec. 1, 2023
(86) PCT No.: PCT/US2023/081995

§ 371 Date: Jun. 2, 2025

Related U.S. Application Data
(60) Provisional application No. 63/429,742, filed on Dec. 2, 2022.

(30) Foreign Application Priority Data
Mar. 16, 2023 (FI) 20235306

(51) Int. Cl. B01F 35/213; B01F 23/40; B01F 23/41; B01F 23/50; B01F 101/00; C08F 20/56; G01N 21/41; G01N 21/84

(52) U.S. Cl. CPC B01F 35/213; B01F 23/4105; B01F 23/48; B01F 23/511; C08F 20/56; G01N 21/4133; B01F 2101/2805; B01F 2215/044; B01F 2215/0468; G01N 2021/8416

(57) ABSTRACT

The present invention provides methods for forming a polymer mixture comprising an aqueous component and a polymer component which method comprises the monitoring of polymer content by refractometry during the method. The present invention also provides methods for adjusting parameters of mixing based on detected refractive indices. The present invention also provides methods for monitoring and modulating aqueous component inlet feed quality based on detected refractive indices.

### RELATED APPLICATIONS

The present application claims benefit of priority to U.S. Provisional Application No. 63/429,742, filed on Dec. 2, 2022, and to Finnish Application Number 20235306 filed on Mar. 15, 2023, the contents both of which are incorporated by reference in their entireties.

### FIELD OF THE INVENTION

The present invention relates to a method for producing a hydrated polymer composition comprising real-time monitoring of polymer concentration and/or dissolution and/or hydration via measurement of the refractive index of the input stream and the polymer mixture during and after mixing. Also, the invention relates to industrial systems for effecting such methods.

### BACKGROUND OF THE INVENTION

Addition of polymers to a process stream is a common step in many industrial applications, including but not limited to, enhanced oil recovery (EOR) techniques including polymer flooding, oil sands petroleum mining and dewatering of tailings, hydraulic fracturing operations, and dewatering of wastewater sludge for municipal water. Other industrial applications include paper and pulp manufacturing, mineral and ore mining, industrial wastewater, storm wastewater, sludge, sewage, paper or pulp wastewater, papermaking whitewater, and oil and mineral industry tailings. Such applications frequently employ water-soluble synthetic or natural polymers for technical purposes including down well injection, flocculation, coagulation, sedimentation, retention enhancement, wet and dry strength enhancement, and fossil fuel mobilization.

Production of aqueous solutions of water-soluble polymers by dissolution of commercial powdered products or inversion of water-in-oil emulsions is difficult to achieve rapidly on a time scale that is efficient for industrial use. When the finely divided powder comes into contact with water, swollen particles may result. These particles may contain a dry interior surrounded by a hydrated exterior, which hinders further dissolution. Although water-soluble in and of themselves, solid polymers often disperse poorly in water, instead forming agglomerates. In order to break up agglomerates or hinder their formation, it is necessary to agitate aqueous polymer mixtures and allow sufficient hydration time prior to subsequent usage of the polymer solution. Incomplete hydration may cause polymers to be improperly dosed or to lose their effectiveness either partially or totally.

In a typical industrial polymer hydration process, prior to addition of a hydrated polymer composition to a process stream, a polymer source, which may be e.g., a dry granulated or powdered polymer, a concentrated aqueous polymer solution, often referred to as a “stock”, a Mannich polymer, or an emulsion polymer, is usually first combined with an aqueous liquid in a mixing chamber or a feed pipe. This forms an initial hydrated polymer composition, which may then be left to hydrate fully, sometimes referred to as “aging” or “activation”. After dissolving/inverting, mixing, and optionally, aging, the final hydrated polymer composition is obtained, which flows out of the mixing chamber and mixes with the process stream.

Optimizing polymer hydration processes allows for more accurate determination of polymer concentration, which is of critical importance for maximizing the efficacy of the hydrated polymer composition, for ensuring proper polymer dosing, and for minimizing batch-to-batch variability. Delivering an insufficient dose of polymer to a treatment stream can reduce separation efficiency downstream, while an excessive dose of polymer increases material costs and can also decrease performance of the system. For maximum efficacy, this hydrated polymer composition must be of the correct concentration and the polymer must be sufficiently hydrated in order to interact efficiently with the components of the process stream.

Polymer hydration, dissolution, and inversion (hereafter, collectively termed “polymer hydration”) depend on several parameters including mixing time, mixing speed, particle size, and water quality (i.e., the total dissolved and/or total suspended material in water used as a polymer diluent). Given the volumes required, conventional polymer dilution is accomplished using fresh water, brine, sea water, process water, well water, surface water, produced water, or a combination thereof. For industrial field applications, process water is often the most readily available and cost effective diluent. Maintaining water quality within predetermined parameters has historically proven difficult due to substantial variability of process water quality.

Process water is water that has been used at least once in an industrial process. Typically, for applications relating to paper and pulp manufacturing, mineral and ore mining, oil sands petroleum mining, and EOR, process water is reclaimed and recycled for used in subsequent processes, including polymer dilution. Reclaimed process water may contain varying amounts of impurities, such as particulate matter, organic matter, dissolved material, or suspended material and; therefore, must be at least partially purified prior to use as a diluent. This purification process, however, poses significant difficulty, due to substantial amounts of impurities that are often not separated from the water. Therefore, the water quality of partially purified process water may be highly variable from batch-to-batch.

Monitoring the batch-to-batch quality of the water used to form the diluted hydrated polymer composition is essential, and is ideally accomplished in real time. Impurities such as oil, grease, total suspended solids (TSS), total dissolved solids (TDS), hardness, and concentration of ions, such as halides (e.g., chlorine) and monovalent metal ions (e.g., alkali metals) can substantially affect the rate of formation of the hydrated polymer composition and the properties of the final diluted hydrated polymer composition. Ensuring consistent polymer dilution in a polymer containing process stream is also highly desirable, and ideally accomplished in real time. Monitoring the formation of the hydrated polymer composition during dilution and mixing is important for assuring complete hydration and dissolution of polymers and for accurate determination of polymer concentration prior to use in subsequent downstream applications.

Polymer concentration is most commonly monitored by removing samples at regular time intervals and performing measurements in a lab. Because of the time gap between sample intake and analysis, this may be unacceptable measurement delays and an increased risk of untimely corrective actions.

Additionally, most industrial processes introduce particulates and bubbles into polymer containing process streams, and many processes involve multiple phases. Removal of these interfering materials typically requires procedures that introduce delays that are not consistent with the response time requirements of a monitor for monitoring and control of a rapidly changing system.

Real time monitoring of polymer dilution within a hydration unit enables operators to get real time data on polymer solution at outlet. The present invention seeks to address the current problems by providing novel methods and systems that facilitate real-time monitoring of polymer content and hydration of polymer mixtures, and integration of such monitoring into an industrial process.

### SUMMARY OF THE INVENTION

The present invention provides methods and processes forming a hydrated polymer composition comprising an aqueous component and a polymer component and monitoring of the aqueous component and the hydrated polymer composition in real-time by refractometry-based methods.

In one aspect, there is provided a method for forming a hydrated polymer composition comprising an aqueous component and a polymer component comprising one or more polymers, which method comprises the monitoring of polymer content by refractometry during the method, the method comprising:
(a) measuring a first refractive index of the aqueous component with a refractometer prior to addition of the polymer component;
(b) contacting an amount of said polymer component with said aqueous component optionally within a mixing tank or a feed pipe to create said hydrated polymer composition;
(c) measuring a second refractive index of said hydrated polymer composition, optionally after it is no longer in contact with the mixing tank or the feed pipe, with the refractometer used in the first refractive index measurement or a different refractometer; and
(d) optionally, measuring a third refractive index of said aqueous component and said polymer component within the mixing tank or feed pipe, with the refractometer used in the first and/or second refractive index measurements or a different refractometer,
wherein steps (a) to (c) or (a) to (d) are effected concurrently or successively; and
(e) further optionally wherein one or more parameters of the method for forming the hydrated polymer composition (further optionally wherein said parameters include one or more of the feed rate of a reagent, polymer or polymer component, the feed rate of an aqueous component, the agitation rate, the agitation time, the temperature, the outlet feed rate, the total dissolved solids (TDS) of the aqueous component, the pH, the pressure, et al.), is/are adjusted based on the detected refractive indices.

In one embodiment, the polymer component comprises one or more of the following:
(a) an emulsion polymer comprising a dispersion of water, greater than about 10% by weight said one or more polymers, one or more emulsifier surfactants, and one or more inverting surfactants dispersed in one or more hydrophobic liquids having a boiling point at least about 100°C, which emulsion polymer is inverted when contacted with said aqueous component to form said hydrated polymer composition;
(b) a dry polymer comprising said one or polymers formulated as granules, as a dry powder, or a combination thereof, further comprising a residual amount of water and optionally buffers, anti-caking additives, anti-dusting agents, and one or more surfactants to facilitate dissolution, which dry polymer is dissolved when contacted with said aqueous component to form said hydrated polymer composition; or
(c) an aqueous stock polymer solution comprising said one or more polymers dissolved in water at a concentration ranging from 500 to 800,000 ppm, 3000 to 100,000 ppm, 4000 to 40,000 ppm, 4000 to 10,000 ppm, from 4000 to 6000 ppm, or from 4500 to 5500 ppm, which aqueous stock polymer solution is diluted when contacted with said aqueous component to form said hydrated polymer composition.

In another embodiment, (a) the one or more emulsifier surfactants are selected from the group consisting of sorbitan esters, ethoxylated fatty alcohols with 1 to 4 ethyleneoxy groups, phthalic esters, fatty acid glycerides, glycerin esters, sorbitan monooleate, the reaction product of oleic acid with isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, and the ethoxylated versions of the foregoing containing 1 to 10 moles of ethylene oxide per mole of the basic emulsifier, modified polyester surfactants, anhydride substituted ethylene copolymers, N,N-dialkanol substituted fatty amides, tallow amine ethoxylates, and mixtures or combinations of the foregoing;
(b) the one or more inverting surfactants are selected from the group consisting of ethoxylated amine compounds, ethoxylated fatty acid compounds, and alkyl polyethyleneglycol ether carboxylic acid compounds, alkyl polyglycol ether carboxylic acid compounds, and salts or esters thereof, ethoxylated alcohols, alcohol ethoxylates, ethoxylated esters of sorbitan, ethoxylated esters of fatty acids, ethoxylated fatty acid esters, ethoxylated esters of sorbitol and fatty acids, nonionic surfactants comprising a hydrocarbon group and a polyalkylenoxy group of sufficient hydrophilic nature, nonionic surfactants of the general formula R1-O—(CH(R2)-CH2-O)nH (I), wherein R1 is a C8-C22-hydrocarbon group, n is a number of 2:4, and R2 is H, methyl or ethyl, and at least 50% of the groups R2 are H, polyethoxylates based on C10-C18-alcohols, tridecylalcohol ethoxylates comprising from 4 to 14 ethylenoxy groups, tridecyalcohol.8 EO, or C12/14 fatty alcohol ethoxylates, C12/14.8 EO, modified polyester surfactants, anhydride substituted ethylene copolymers, N,N-dialkanol substituted fatty amides, tallow amine ethoxylates, and mixtures and combinations of the forgoing; and
(c) the one or more hydrophobic liquids having a boiling point at least about 100 °C is selected from the group consisting of paraffin hydrocarbons, naphthene hydrocarbons, aromatic hydrocarbons, olefins, oils, stabilizing surfactants, and mixtures or combinations of the foregoing.

In another embodiment, (a) said hydrated polymer composition is formed in a polymer mixing tank, in a polymer aging tank, in a polymer hydration unit, in a turbulent feed line or pipe, in a static feed line or pipe, in a polymer make down or make up unit, on-site, in a remote setting, or in an industrial or laboratory setting;
(b) said aqueous component comprises water, produced water, fresh water, salt water, brine, sea water, ground water, surface water, or reclaimed water, wastewater, municipal wastewater, industrial wastewater, paper or pulp wastewater, storm wastewater, mining tailings, oil sands tailings, sludge, papermaking whitewater, or a combination thereof;
(c) said one or more polymers comprise anionic, cationic, amphoteric, or non-ionic (neutral) polymers;
(d) said one or more polymers comprises one or more copolymers, terpolymers, linear polymers, branched polymers, cross-linked polymers, cationic polymers, anionic polymers, non-ionic polymers, grafted polymers, modified polymers, or any combination of the foregoing;
(e) said one or more polymers comprises one or more copolymers, terpolymers, linear polymers, branched polymers, cross-linked polymers, cationic polymers, anionic polymers, non-ionic polymers, grafted polymers, or modified polymers optionally selected from anionic, cationic or neutral polyacrylamide polymers and copolymers, including but not limited to, Acrylamide/Acrylic Acid copolymers, Acrylamide/acrylamido tertiary butyl sulfonic acid (ATBS aka AMPS) copolymers, Acrylamide/Acrylic Acid/ATBS terpolymer, Acrylamide/acryloyloxy ethyl trimethyl ammonium chloride (AETAC) cationic polyacrylamide copolymers, partially hydrolyzed acrylamide, or other acrylamide containing polymers, poly(ethylene oxide polymers), poly(propylene oxide polymers), polyacrylate polymers, a poly(maleic acid) polymers, poly(itaconic acid) polymers, poly(diallyldimethylammonium chloride) polymers, polyvinyl pyrrolidone polymers, polyvinyl alcohol polymers, poly(styrenic sulfonic acid) polymers, polyamine polymers and copolymers such as copolymers of dimethylamine and epichlorohydrin), polyamidoamine-epichlorohydrin copolymers, polyethyleneimine polymers, polyethylene glycols, cellulose and cellulose derivative comprising polymers such as carboxymethylcellulose (CMC), Methylcellulose (MC), ethylcellulose (EC), hydroxypropylcellulose (HPC), hydroxyethylcellulose (HEC), and hydroxypropylmethylcellulose (HPMC) polymers, carrageenans, agars, alginates, guar gums, locust bean gums, a gum tragacanth, a konjac glucomannan, a tara gum, a cassia gum, a gum arabic, a pectin, a starch, a xanthan gum, a gellan gum, a pullulan, a curdlan, a dextran, a welan gum, a rhamsan, a succinoglycan, cellulose gum, a modified starch, a propylene glycol alginate, modified guar gums, chitosans, polyphosphonates, and alfa and beta glucans, including but not limited to scleroglucan and schizophyllan;
(f) said polymer component comprises a plurality of different polymers;
(g) the molecular weight of said one or more polymers ranges from 500 Da to 200,000,000 Da, or from 10,000 Da to 100,000,000 Da, or from 10,000 Da to 50,000,000 Da or from 10,000 Da to 20,000,000 Da, or from 10,000 Da to 10,000,000 Da or from 10,000 Da to 1,000,000 Da or from 10,000 Da to 500,000 Da or from 10,000 Da to 100,000 Da;
(h) the concentration after mixing of said one or more polymers in said hydrated polymer composition is between 1 ppm and 800,000 ppm or between 1 and 300,000 ppm; or between 1 and 100,000 ppm; or between 1 and 20,000 ppm; or between 1 and 10,000 ppm; or between 1 and 1,000 ppm; or
(i) any combination of (a) to (h).

In another embodiment, (a) said one or more polymers comprise an acrylamide-containing polymer comprising acrylamide, acrylic acid or any salt thereof, and optionally one or more additional cationic and/or anionic monomers;
(b) said one or more polymers comprise an acrylamide-containing polymer comprising acrylamide, acrylamido tertiary butyl sulfonic acid (ATBS) or any salt thereof, and optionally one or more additional cationic and/or anionic monomers; or
(c) said one or more polymers comprise an acrylamide-containing polymer comprising acrylamide, acrylic acid or any salt thereof, acrylamido tertiary butyl sulfonic acid (ATBS) or any salt thereof, and optionally one or more additional cationic and/or anionic monomers.

In some embodiments the method comprises one or more of the following:
(a) the method is effected continuously or periodically;
(b) the method is effected in an in-line manner on site, remotely on site, at a sampling point, or in a lab;
(c) there is a correlation between the second refractive index and a concentration of said one or more polymers in said hydrated polymer composition;
(d) there is a correlation between the second refractive index and a viscosity of said hydrated polymer composition;
(e) in (c) or (d) the correlation between the second refractive index and the concentration of said one or more polymers in said hydrated polymer composition is independent of the total dissolved solids (TDS) in mg/kg or the relative hardness in mol % of the aqueous component;
(f) said first, second, and third refractive indices are measured in real time;
(g) the results are electronically transmitted to another site, to a graphical user interface, to a controller, or to a feedback loop;
(h) said first refractive index is compared to said second refractive index or to said third refractive index to determine at least one property of said hydrated polymer composition; optionally wherein said at least one property comprises concentration, amount of hydration, a percent dissolution of said polymer, or combination thereof;
(i) said at least one property is determined more rapidly compared to an industrial analysis method comprising on-site sampling followed by laboratory analysis of concentration, viscosity, amount of hydration, or percent dissolution of said polymer;
(j) a first flow rate of said aqueous component or a second flow rate of said polymer component is adjusted based on the values of said first refractive index, said second refractive index and/or said third refractive index;
(k) said first refractive index and/or said second refractive index positively correlate with measurements of the viscosity of said aqueous component and/or said hydrated polymer composition;
(l) the hydrated polymer composition is optionally subjected to a secondary dilution step, wherein the secondary dilution step comprises addition of the hydrated polymer composition to a process water stream to form a second hydrated polymer composition;
(m) the hydrated polymer composition or the second hydrated polymer composition is used in an industrial application including but not limited to mining, petroleum extraction, enhanced oil recovery, oil sands processing, oil sands tailings treatment, paper or pulp manufacture, industrial water treatment, municipal water treatment, surface water treatment, storm water treatment, and agricultural waste treatment; or
(n) a combination of one or more of (a) to (m).

In another aspect, there is provided a method for forming a hydrated polymer composition comprising a first aqueous component and a polymer component comprising one or more polymers, which method comprises real-time monitoring of polymer content by refractometry during the method, the method comprising:
(a) measuring in real time a first refractive index of an aqueous inlet stream comprising the first aqueous component with a first refractometer, wherein said first refractive index is measured prior to contacting the first aqueous component with the polymer component;
(b) feeding said first aqueous inlet stream into a mixing tank or pipe at a first feed rate and feeding a polymer inlet stream comprising the polymer component into the mixing tank or pipe at a second feed rate;
(c) allowing the first aqueous component to contact the polymer component, thereby forming an initial hydrated polymer composition;
(d) agitating said initial hydrated polymer composition at an agitation rate for an agitation time;
(e) allowing the hydrated polymer composition to exit the mixing tank or pipe at an outlet rate as an outlet stream comprising the hydrated polymer composition and measuring in real time a second refractive index of the outlet stream with a second refractometer;
(f) optionally, measuring a third refractive index of the initial hydrated polymer composition in real time with a third refractometer, wherein said third refractometer is located inside the mixing tank or pipe and in contact with the initial hydrated polymer composition;
wherein steps (a)-(f) are effected concurrently, successively, or in any order; and
(g) further optionally wherein one or more parameters of the method for forming the hydrated polymer composition (further optionally wherein said parameters include one or more of the feed rate of a reagent, polymer or polymer component, the feed rate of an aqueous component, the agitation rate, the agitation time, the temperature, the outlet feed rate, the total dissolved solids (TDS) of the aqueous component, the pH, the pressure, et al.), is/are adjusted based on the detected refractive indices.

In one embodiment, the polymer component comprises one of the following:
(a) an emulsion polymer comprising a dispersion of water, greater than about 10% by weight said one or more polymers, one or more emulsifier surfactants, and one or more inverting surfactants dispersed in one or more hydrophobic liquids having a boiling point at least about 100 °C, which emulsion polymer is inverted when contacted with said aqueous component to form said hydrated polymer composition;
(b) a dry polymer comprising said one or polymers formulated as granules, as a dry powder, or a combination thereof, further comprising a residual amount of water and optionally buffers, anti-caking additives, anti-dusting agents, and one or more surfactants to facilitate dissolution, which dry polymer is dissolved when contacted with said aqueous component to form said hydrated polymer composition; or
(c) an aqueous stock polymer solution comprising said one or more polymers dissolved in water at a concentration ranging from 500 to 800,000 ppm, 3000 to 100,000 ppm, 4000 to 40,000 ppm, 4000 to 10,000 ppm, from 4000 to 6000 ppm, or from 4500 to 5500 ppm, which aqueous stock polymer solution is diluted when contacted with said aqueous component to form said hydrated polymer composition.

In one embodiment, (a) the one or more emulsifier surfactants are selected from the group consisting of sorbitan esters, ethoxylated fatty alcohols with 1 to 4 ethyleneoxy groups, phthalic esters, fatty acid glycerides, glycerin esters, sorbitan monooleate, the reaction product of oleic acid with isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, and the ethoxylated versions of the foregoing containing 1 to 10 moles of ethylene oxide per mole of the basic emulsifier, modified polyester surfactants, anhydride substituted ethylene copolymers, N,N-dialkanol substituted fatty amides, tallow amine ethoxylates, and mixtures or combinations of the foregoing;
(b) the one or more inverting surfactants are selected from the group consisting of ethoxylated amine compounds, ethoxylated fatty acid compounds, and alkyl polyethyleneglycol ether carboxylic acid compounds, alkyl polyglycol ether carboxylic acid compounds, and salts or esters thereof, ethoxylated alcohols, alcohol ethoxylates, ethoxylated esters of sorbitan, ethoxylated esters of fatty acids, ethoxylated fatty acid esters, ethoxylated esters of sorbitol and fatty acids, nonionic surfactants comprising a hydrocarbon group and a polyalkylenoxy group of sufficient hydrophilic nature, nonionic surfactants of the general formula R1-O—(CH(R2)-CH2-O)nH (I), wherein R1 is a C8-C22-hydrocarbon group, n is a number of 2:4, and R2 is H, methyl or ethyl, and at least 50% of the groups R2 are H, polyethoxylates based on C10-C18-alcohols, tridecylalcohol ethoxylates comprising from 4 to 14 ethylenoxy groups, tridecyalcohol.8 EO, or C12/14 fatty alcohol ethoxylates, C12/14.8 EO, modified polyester surfactants, anhydride substituted ethylene copolymers, N,N-dialkanol substituted fatty amides, tallow amine ethoxylates, and mixtures and combinations of the forgoing; and
(c) the one or more hydrophobic liquids having a boiling point at least about 100 °C is selected from the group consisting of paraffin hydrocarbons, naphthene hydrocarbons, aromatic hydrocarbons, olefins, oils, stabilizing surfactants, and mixtures or combinations of the foregoing.

In some embodiments, the method comprises one or more of the following: (i) the first refractometer is positioned in contact with the first aqueous component prior to entering the mixing tank or pipe and the second refractometer is positioned in contact with the hydrated polymer composition after exiting the mixing tank or pipe;
(ii) a third refractive index of the initial hydrated polymer composition is measured in real time with a third refractometer, wherein said third refractometer is located inside the mixing tank or pipe and in contact with the initial hydrated polymer composition;
(iii) said first refractive index is used to determine a background signal and a real-time property of the inlet stream, including but not limited to, a total dissolved solids (TDS) in mg/kg and a relative hardness in mol %;
(iv) at least one of said real-time properties of the inlet stream is adjusted to remain within predetermined limits based on said first refractive index, optionally wherein said first aqueous component of said inlet stream is modified by addition of a second aqueous component to form a partially purified inlet stream based on any combination of said real-time properties of the inlet stream, wherein the TDS, total polymer concentration, relative hardness, and/or viscosity of the second aqueous component is less than the first aqueous component;
(v) said first refractive index is subtracted from said second refractive index to determine a real-time property of the outlet stream selected from the group of properties consisting of a total polymer concentration, a viscosity, an amount of polymer hydration, a percent of polymer dissolution, or any combination thereof;
(vi) a first parameter of mixing is adjusted based on any combination of said real-time properties of the outlet stream selected from the group of parameters consisting of the first feed rate, the second feed rate, the feed rate of said second aqueous component, the agitation rate, the agitation time, the temperature of the mixing tank or pipe, the outlet feed rate, the TDS of said first aqueous component, the pH, or any combination thereof;
(vii) said first refractive index is subtracted from said third refractive index to determine a real-time property of the initial hydrated polymer composition selected from the group of properties consisting of a total polymer concentration, a viscosity, an amount of polymer hydration, a percent of polymer dissolution, or any combination thereof;
(viii) a second parameter of mixing is adjusted based on any combination of said real-time properties of the initial hydrated polymer composition selected from the group of properties consisting of the first feed rate, the second feed rate, the agitation rate, the agitation time, the temperature of the mixing tank or pipe, the outlet feed rate, or any combination thereof;
(ix) if the first, second, and/or third refractive indices deviates from a predetermined upper or lower threshold an alarm is triggered and/or a corrective response is triggered to return the refractive index to within said predetermined upper or lower threshold;
(x) the mixing tank or pipe is heated or cooled based on said real-time property of the initial hydrated polymer composition, said real-time property of the outlet stream, or a combination thereof; or
(xi) any combination of (i) to (x).

In some embodiments, (a) the method is effected continuously or periodically;
(b) the method is effected in a polymer hydration plant, in an on-site field application, or in a lab;
(c) said first aqueous inlet stream and said polymer inlet stream are added to the mixing tank or pipe simultaneously or separately;
(d) the mixing tank or pipe comprises a static tank, a feed pipe, a feed pipe with turbulent flow, a mechanical mixer, a static mixer, a magnetic agitator, a hydrodynamic mixer, a rocking tank, a hydraulic mixer, a polymer hydration unit, a polymer make down or make up unit, an agitator with mechanical stirrer, or any combination of the foregoing;
(e) the method is optionally run in an industrial or lab setting outside of a polymer hydration unit;
(f) said first refractive index, said second refractive index, said third refractive index, said real-time property of the inlet stream said real-time property of the initial hydrated polymer composition, and said real-time property of the outlet stream are measured periodically or continuously;
(g) said inlet stream, said first parameter of mixing, and/or said second parameter of mixing is modified once, periodically, or continuously;
(h) any or all of the refractometry results or real time properties are electronically transmitted to another site, to a graphical user interface, to a controller, and/or to a feedback loop;
(i) the method is run under pressure, wherein said pressure is greater than or equal to atmospheric pressure, further wherein said pressure ranges from 0.2 to 250 bar, or from 0.2 to 100 bar, or from 0.2 to 50 bar, or from 0.2 to 10-200 bar, or from 0.2 to 5 bar, typically 1-3 bar and more typically 1.5 to 2.0 bar; or
(i) any combination of (a)-(i).

In some embodiments,
(a) the first aqueous component comprises water, produced water, fresh water, salt water, brine, sea water, ground water, surface water, or reclaimed water, wastewater, municipal wastewater, industrial wastewater, paper or pulp wastewater, storm wastewater, mining tailings, oil sands tailings, sludge, papermaking whitewater, or a combination thereof;
(b) the first aqueous component comprises a total dissolved solids ranging from 0-500,000 mg/kg, or from 10-100,000 mg/kg, or from 10-50,000 mg/kg;
(c) the first aqueous component comprises a relative hardness ranging from 0.01-50 mol %, or from 0.1-10 mol %;
(d) said one or more polymers comprise one or more anionic, cationic, amphoteric, or non-ionic (neutral) polymers;
(e) said one or more polymers comprise one or more copolymers, terpolymers, linear polymers, branched polymers, cross-linked polymers, cationic polymers, anionic polymers, non-ionic polymers, grafted polymers, modified polymers, or any combination of the foregoing;
(f) said one or more polymers comprise one or more copolymers, terpolymers, linear polymers, branched polymers, cross-linked polymers, cationic polymers, anionic polymers, non-ionic polymers, grafted polymers, or modified polymers optionally selected from anionic, cationic or neutral polyacrylamide polymers and copolymers, including but not limited to, Acrylamide/Acrylic Acid copolymers, Acrylamide/acrylamido tertiary butyl sulfonic acid (ATBS aka AMPS) copolymers, Acrylamide/Acrylic Acid/ATBS terpolymers, Acrylamide/acryloyloxy ethyl trimethyl ammonium chloride (AETAC) cationic polyacrylamide copolymers, partially hydrolyzed acrylamide, or other acrylamide containing polymers, poly(ethylene oxide polymers), poly(propylene oxide polymers), polyacrylate polymers, a poly(maleic acid) polymers, poly(itaconic acid) polymers, poly(diallyldimethylammonium chloride) polymers, polyvinyl pyrrolidone polymers, polyvinyl alcohol polymers, poly(styrenic sulfonic acid) polymers, polyamine polymers and copolymers such as copolymers of dimethylamine and epichlorohydrin), polyamidoamine-epichlorohydrin copolymers, polyethyleneimine polymers, polyethylene glycols, cellulose and cellulose derivative comprising polymers such as carboxymethylcellulose (CMC), Methylcellulose (MC), ethylcellulose (EC), hydroxypropylcellulose (HPC), hydroxyethylcellulose (HEC), and hydroxypropylmethylcellulose (HPMC) polymers, carrageenans, agars, alginates, guar gums, locust bean gums, a gum tragacanth, a konjac glucomannan, a tara gum, a cassia gum, a gum arabic, a pectin, a starch, a xanthan gum, a gellan gum, a pullulan, a curdlan, a dextran, a welan gum, a rhamsan, a succinoglycan, cellulose gum, a modified starch, a propylene glycol alginate, modified guar gums, chitosans, polyphosphonates, and alfa and beta glucans, including but not limited to scleroglucan and schizophyllan;
(g) said polymer component comprises a plurality of different polymers;
(h) the molecular weight of said one or more polymers ranges from 500 Da to 200,000,000 Da, or from 10,000 Da to 100,000,000 Da, or from 10,000 Da to 50,000,000 Da or from 10,000 Da to 20,000,000 Da, or from 10,000 Da to 10,000,000 Da or from 10,000 Da to 1,000,000 Da or from 10,000 Da to 500,000 Da or from 10,000 Da to 100,000 Da; and
(i) the concentration after mixing of said one or more polymers in said hydrated polymer composition is between 1 ppm and 800,000 ppm or between 1 and 300,000 ppm; or between 1 and 100,000 ppm; or between 1 and 20,000 ppm; or between 1 and 10,000 ppm; or between 1 and 1,000 ppm; or
(j) any combination of (a) to (i).

In some embodiments, (a) said one or more polymers comprise an acrylamide-containing polymer comprising acrylamide, acrylic acid or any salt thereof, and optionally one or more additional cationic and/or anionic monomers;
(b) said one or more polymers comprise an acrylamide-containing polymer comprising acrylamide, acrylamido tertiary butyl sulfonic acid (ATBS) or any salt thereof, and optionally one or more additional cationic and/or anionic monomers; or
(c) said one or more polymers comprise an acrylamide-containing polymer comprising acrylamide, acrylic acid or any salt thereof, acrylamido tertiary butyl sulfonic acid (ATBS) or any salt thereof, and optionally one or more additional cationic and/or anionic monomers.

In some embodiments, (a) there is a positive correlation between said second refractive index and the amount of hydration of the polymer component in said hydrated polymer composition;
(b) there is a positive correlation between said second refractive index and the percent dissolution of the polymer component in said hydrated polymer composition;
(c) there is a positive correlation between said third refractive index and the amount of hydration of the polymer component in said initial hydrated polymer composition;
(d) there is a positive correlation between said third refractive index and the percent dissolution of the polymer component in said initial hydrated polymer composition;
(e) there is a correlation between said second refractive index and the final concentration of said polymer component in said hydrated polymer composition;
(f) there is a correlation between said second refractive index and the viscosity of said hydrated polymer composition;
(g) there is a correlation between said third refractive index and the concentration of said polymer component in said initial hydrated polymer composition;
(h) there is a correlation between said third refractive index and the viscosity of said initial hydrated polymer composition; or
(i) a combination of one or more of (a) to (h).

In some embodiments, the hydrated polymer composition is optionally subjected to a secondary dilution step, wherein the secondary dilution step comprises addition of the hydrated polymer composition to a process water stream to form a second hydrated polymer composition;
the hydrated polymer composition or the second hydrated polymer composition is used in an industrial process relating to any phase of the oil sand mining processes including, but not limited to, recovery, extraction, refining, dewatering, and waste treatment; enhanced oil recovery, any mineral mining or mineral processing operation, sludge dewatering; pulp and papermaking, municipal wastewater treatment, oil and gas fracking, and any industrial process which requires polymer hydration or polymer inversion;
said real-time property is determined more rapidly compared to an industrial analysis method comprising on-site sampling followed by laboratory analysis of concentration, viscosity, amount of hydration, or percent dissolution of said polymer; and/or
said method optionally comprises on-site sampling of one or more of said aqueous inlet stream, said initial hydrated polymer composition, and said outlet stream followed by laboratory validation of said first refractive index, said second refractive index, and said third refractive index.

The examples provided herein are for illustrative purposes so that the invention may be more fully understood. These examples should not be construed as limiting the invention in any way.

### BRIEF DESCRIPTION OF THE DRAWINGS

The invention will be described in more detail with reference to appended drawings, described in detail below.

FIG. 1 provides an exemplary flow diagram of material flow (solid arrows) and refractometer placement according to Example 1.

FIG. 2 provides an exemplary flow diagram of material flow (solid arrows), data flow (dashed arrows) to and from a multichannel interface controller, and refractometer placement according to Example 1.

FIG. 3 provides an exemplary flow diagram of material flow (solid lines), data flow (dashed lines), and refractometer placement in an industrial process for treating tailings streams according to Example 1.

FIG. 4 provides an exemplary flow diagram of an industrial setup for real time monitoring of polymer concentration with inline refractometer cleaning apparatus according to Example 1.

FIGS. 5A-B provide exemplary graphs of refractive index vs. polymer concentration for aqueous polymer solutions prepared according to Example 2. FIG. 5A shows refractive indices and linear curve fitting for polymer 1 (top) and polymer 2 (bottom) dissolved in synthetic brine. FIG. 5B shows refractive indices and linear curve fitting for polymer 1 dissolved in synthetic brine (top) and field water (bottom).

FIGS. 6A-B provide exemplary graphs of refractive index vs. polymer concentration for aqueous polymer solutions prepared according to Example 3. FIG. 6A shows refractive indices and linear curve fitting for polymer 3 dissolved in synthetic brine 1. FIG. 6B shows refractive indices and linear curve fitting for polymer 3 is dissolved in synthetic brine 1 (top) and synthetic brine 2 (bottom).

FIG. 7 provides an exemplary graph indicating viscosity (top) and refractive index (bottom) of a mixture of oil sand polymer and oil sand field water over time according to Example 4.

### DETAILED DESCRIPTION OF THE INVENTION

Before describing the invention, the following definitions are provided. Unless stated otherwise all terms are to be construed as they would be by a person skilled in the art.

### DEFINITIONS

As used herein the singular forms “a”, “and”, and “the” include plural referents unless the context clearly dictates otherwise.

The term “aqueous component” generally refers to any aqueous liquid or solution used to hydrate a polymer composition. The source of which may be tap water, fresh water, brine, or water recycled from an industrial or water treatment process.

The term “polymer component” generally refers to any composition comprising a polymer, which is added to an aqueous component in order to make a hydrated polymer composition for use in treating a process stream.

The term “process stream” generally refers to any aqueous fluids or slurries produced during any type of industrial process or water treatment process, for example, an oil or gas extraction or recovery process, waste treatment process, sewage treatment, paper or pulp manufacture, food processing, or any portion thereof. An exemplary process stream includes a diluted bitumen product, such as an oil sand slurry, from any phase of the oil sand mining process including recovery, extraction, refining, or waste treatment.

The terms “tailings” and “tailings stream” generally refer to the discarded materials that may be generated in the course of extracting a valuable material from an ore. Generally, any mining or mineral processing operation that uses water to convey or wash materials will typically generate a tailings stream. Exemplary tailings include, but are not limited to, tailings from oil mining, coal mining, copper mining, gold mining, and mineral processing, such as, for example, processing of phosphate, diamond, gold, mineral sands, zinc, lead, copper, silver, uranium, nickel, iron ore, coal, oil sands, and/or red mud. Exemplary tailings for the present application include tailings from the processing of oil sands. While many of the embodiments are described with reference to oil sands tailings, it is understood that the embodiments, including compositions, processes, and methods, are not limited to applications in oil sands tailings, but also can be applied to various other tailings. The term “tailings” is meant to be inclusive of but not limited to any of the types of tailings discussed herein, for example, process oil sand tailings, in-process tailings, oil sands tailings, and the like.

The terms “oil sands tailings”, “oil sands tailings stream”, “oil sands process tailings”, or, “process oil sand tailings” generally refer to tailings that may be generated as bitumen is extracted from oil sands. Oil sands tailings are generally a mixture of water, sand, fine silts, clay, residual bitumen and lighter hydrocarbons, inorganic salts and water-soluble organic compounds. In tar sand processing, tailings may comprise the whole tar sand ore and any net additions of process water less the recovered bitumen.

The term “coagulant” generally may refer to an agent that may typically destabilize colloidal dispersions to facilitate coagulation, a process of agglomerating colloidal particles into larger particles. Coagulants are added to facilitate removal of suspended solids for process streams, thereby reducing turbidity of the aqueous fraction.

The term “flocculant” may generally refer to a reagent that may bridge neutralized or coagulated particles into larger agglomerates, typically resulting in more efficient settling. Flocculation process generally involves addition of a flocculant followed by mixing to facilitate collisions between particles, allowing for the destabilized particles to agglomerate into larger particles that can be removed by gravity through sedimentation or by other means, e.g., centrifugation, filtration.

The terms “aqueous suspension” or “aqueous dispersion”, or “aqueous solid dispersion stream” generally refer to a heterogeneous mixture of a fluid that contains solid particles, wherein the solid particles forms a phase separated mixture in which one substance of macroscopically or microscopically dispersed insoluble or soluble particles is suspended throughout another substance, typically a liquid substance. A dispersion has a dispersed phase (the suspended particles) and a continuous phase (the medium of suspension) that arise by phase separation. Macroscopic particles typically separate and settle quickly, while colloids typically do not completely settle or take a long time to settle completely into two separated layers.

The terms “real time detecting” or “real time monitoring” refer generally to a system in which detection of a phenomena within a sample occurs rapidly and input data is processed and is available virtually immediately for visualization and feedback with little lag time between the actual event and said visualization and feedback. The output signals from the sensor may be sent to a graphical user interface, and/or sent to a controller, control loop, or feedback loop, to maintain parameters within specified limits.

The term “online” herein means real time detection and/or control of a parameter during an industrial process, e.g., an oil sands treatment method. This includes embodiments where the sensor is not physically connected to a computer, e.g., the data is collected real time and stored on sensor memory cards and extracted later for analysis. Also, “online” includes embodiments where a sensor provides for real time detection and/or the control of a process parameter such as by connection to another computer or to a network.

The term “controller” or “control loop” or “feedback loop” herein refers to a system that uses computers/networks to monitor various sensors, including but not limited to refractometer sensors for monitoring polymer concentration, for recording and controlling processes (e.g., addition of polymer, dilution water, parameters of mixing, etc.), that involve the use of proprietary chemicals at customer plants such as temperature, pH, pressure, particle size distribution, the speed or velocity of the influx or efflux of the aqueous colloidal dispersion through the system, solid-liquid separation rate, dosage of one or more chemicals, amount of free or dissolved air in the sample, or any combination of the foregoing.

The phrase “monitoring of polymer content” or “monitoring polymer content” refers to assessing one or more chemical or physical characteristics of a polymer or mixture of polymers in a solution or slurry. Examples of chemical or physical characteristics include, concentration, amount of hydration, percent dissolution, viscosity, percent ionization, percent hydrolysis of hydrolysable monomer units within the polymer, percent degradation, total dissolved solids (TDS), turbidity, and any other characteristic of a hydrated polymer composition which may be monitored by refractometry.

The phrase “monitoring of feed water quality”, “monitoring aqueous component quality”, or “monitoring aqueous component” refers to assessing one or more chemical or physical characteristics of a liquid or aqueous slurry which is used to hydrate, dilute, or dissolve, or invert a polymer or mixture of polymers. Examples of chemical or physical characteristics include, concentration, TDS, hardness, turbidity, density, purity, or any other characteristic of an aqueous component which may be monitored by refractometry.

The term “liquid polymer mixture” refers to a combination of at least one polymer and a liquid, typically an aqueous liquid. The polymer in a may be thoroughly dissolved or may be a partially dissolved suspension, dispersion, or slurry. An “aqueous polymer mixture” or “hydrated polymer composition” refers to a combination of at least one polymer and an aqueous liquid. When a dry polymer is combined with an aqueous liquid, the polymer is initially partially hydrated at the polymer-water interface. Polymers do not dissolve instantaneously in aqueous or non-aqueous solvents. Dissolution is controlled by either the disentanglement of the polymer chains or by the diffusion of the chains through a boundary layer adjacent to the polymer-solvent interface. After thorough mixing, the polymer may become fully hydrated, at which point the wetting process is complete and the polymer may be either partially dissolved or fully dissolved, depending on the nature and composition of the polymer and solvent.

The term “mixing chamber” refers to any vessel, pipe, or feed line wherein at least one polymer and aqueous component may be combined. The mixing chamber may allow for static mixing, turbulent flow mixing, or mixing with agitation, shaking, or stirring to form a hydrated polymer composition.

The term “in-line” refers to any point in an industrial process relating to polymer hydration, dilution, dissolution, and inversion, and any point in an industrial process relating to use of a polymer slurry or solution.

As used herein, “enhanced oil recovery” (abbreviated “EOR”) refers to various techniques for increasing the amount of crude oil that can be extracted from an oil field that conventional techniques do not recover.

The terms “polymer” or “polymeric additives” and similar terms are used in their ordinary sense as understood by one skilled in the art, and thus may be used herein to refer to or describe a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, for example, polymerizing, a particular monomer. Unless otherwise specified, a polymer may also comprise a “copolymer” that may comprise two or more different recurring units that may be formed by, for example, copolymerizing, two or more different monomers, and/or by chemically modifying one or more recurring units of a precursor polymer. Unless otherwise specified, a polymer or copolymer may also comprise a “terpolymer” which generally refers to a polymer that comprises three or more different recurring units. Any one of the one or more polymers discussed herein may be used in any applicable process, for example, as a flocculant.

As used herein, “inverted” means that the liquid polymer composition is dissolved in an aqueous solution, so that the dispersed polymer phase of the liquid polymer composition becomes a substantially continuous phase, and the hydrophobic liquid phase becomes a dispersed, discontinuous phase. The inversion point can be characterized as the point at which the viscosity of the inverted polymer solution has substantially reached its maximum under a given set of conditions. In practice, this may be determined for example by measuring viscosity of the composition periodically over time and when three consecutive measurements are within the standard of error for the measurement, then the solution is considered inverted.

As used herein, “polymer flooding” refers to an enhanced oil recovery technique using water viscosified with soluble polymers. Polymer flooding can yield a significant increase in oil recovery compared to conventional water flooding techniques. Viscosity is increased until the mobility of the injectant is less than that of the oil phase in place, so the mobility ratio is less than unity. This condition maximizes oil-recovery sweep efficiency, creating a smooth flood front without viscous fingering. Polymer flooding is also applied to heterogeneous reservoirs; the viscous injectant flows along high-permeability layers, decreasing the flow rates within them and enhancing sweep of zones with lower permeabilities. The two polymers that are used most frequently in polymer flooding are partially hydrolyzed polyacrylamide and acrylamide copolymers. A typical polymer flood project involves mixing and injecting polymer over an extended period of time until at least about half of the reservoir pore volume has been injected.

As used herein, the term “acrylamide polymer” refers to a homopolymer of acrylamide and encompasses acrylamide polymers chemically modified (e.g., hydrolyzed) following polymerization.

As used herein the term “acrylamide copolymer” or “acrylamide-containing copolymer” refers to a polymer (copolymer, terpolymer, etc.) comprising an acrylamide monomer and one or more additional comonomers. The comonomer may be anionic, cationic or non-ionic. In certain embodiments, the comonomer is hydrophilic. The acrylamide copolymer may be unmodified or chemically modified. Representative, non-limiting co-monomers include acrylic acid and salts thereof, acrylamido tertiary butyl sulfonic acid (ATBS) and salts thereof, acryloyloxy ethyl trimethyl ammonium chloride (AETAC) and salts thereof, vinyl acetate, vinyl alcohol and/or other unsaturated vinyl monomers. In certain embodiments, the acrylamide-containing copolymer comprises acrylic acid comonomers.

As used herein the term “hydrolyzed acrylamide” or “partially hydrolyzed acrylamide” refers to an acrylamide containing polymer which has been partially reacted with caustic (basic) water to form acrylate or acrylic acid side chains, thereby forming an Acrylamide/Acrylic Acid (or acrylate) copolymer. For example, an Acrylamide/Acrylic Acid copolymer may be obtained by polymerizing acrylamide and then hydrolyzing some acrylamide monomers to acrylic acid. The same polymer may be obtained by reacting acrylamide and acrylic acid monomers in a polymerization reaction.

As used herein, “emulsion polymer” generally refers to inverse emulsions (water-in-oil) in which water droplets containing the polymer are suspended in an oil phase, also termed a hydrophobic phase. In some embodiments, the emulsion polymer comprises a small amount of water, for example less than about 12%, about 10%, about 5%, about 3%, about 2.5%, about 2%, or about 1% by weight water, based on the total amount of all components of the emulsion polymer.

As used herein, “emulsion polyacrylamide (EPAM)” refers to an emulsion polymer in which at least one polymer is an acrylamide containing polymer. In some embodiments, the emulsion polyacrylamide (EPAM) comprises a small amount of water, for example less than about 12%, about 10%, about 5%, about 3%, about 2.5%, about 2%, or about 1% by weight water, based on the total amount of all components of the emulsion polyacrylamide (EPAM).

As used herein, “nonionic monomer” refers to a monomer which possesses a net charge of zero in aqueous solution. Non-limiting examples of nonionic monomers include, acrylamide, N-alkylacrylamides, N,N-dialkylacrylamides, methacrylamide, N-vinylmethylacetamide or formamide, vinyl acetate, vinyl pyrrolidone, alkyl methacrylates, acrylonitrile, N-vinylpyrrolidone other acrylic (or other ethylenically unsaturated) ester or other water insoluble vinyl monomers such as styrene or acrylonitrile.

As used herein, “anionic monomer” refers to a monomer which possesses a negative charge in aqueous solution. Non-limiting representative anionic monomers include acrylic acid, sodium acrylate, ammonium acrylate, methacrylic acid, 2-acrylamido-2-methylpropanesulfonic acid (AMPS), vinyl sulfonic acid, styrene sulfonic acid, maleic acid, sulfopropyl acrylate or methacrylate or other water-soluble forms of these or other polymerizable carboxylic or sulphonic acids, sulfomethylated acrylamide, ally sulfonate, itaconic acid, acrylamidomethylbutanoic acid, fumaric acid, vinylphosphonic acid, allylphosphonic acid, phosphonomethylated acrylamide, methacrylate, itaconate, 2-acrylamido 2-methyl propane sulphonate, sulfoalkyl(meth)acrylic acids, sulfonated styrenes, unsaturated dicarboxylic acids, sulfoalkyl(meth)acrylamides, vinyl acetate, n-vinylformamide, n-vinylacetamide, n-vinylcaprolactam, n-vinylimidazole, n-vinylpyridine, n-vinylpyrolidone, acrylamidopropyltrimonium chloride, salts of said acids and the like, or another anionic ethylenically unsaturated compound.

As used herein, the term “cationic monomer” refers to a monomer which possesses a positive charge. Representative cationic monomers include dialkylaminoalkyl acrylates and methacrylates and their quaternary or acid salts, including, but not limited to, dimethylaminoethyl acrylate methyl chloride quaternary salt, dimethylaminoethyl acrylate methyl sulfate quaternary salt, dimethyaminoethyl acrylate benzyl chloride quaternary salt, dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, acryloyloxyethyltrimethylammonium chloride, diethylaminoethylacrylate, diethylaminoethylmethacrylate and diallyldialkylammonium halides such as diallyldiethylammonium chloride and diallyldimethyl ammonium chloride. Alkyl groups are generally C₁₋₈ alkyl.

As used herein, “dry polymer” refers to a solid polymer in powder form, in granular form, or a combination thereof, which contains little water or is anhydrous. A non-limiting example is polyacrylamide powder, or dry polyacrylamide (DPAM), is an acrylamide-containing polymer or copolymer.

The term “brine” or “aqueous brine” as used herein refers to sea water; naturally-occurring brine; a chloride based, bromide-based, formate-based, or acetate-based brine containing monovalent and/or polyvalent cations or combinations thereof. Examples of suitable chloride-based brines include without limitation sodium chloride and calcium chloride. Further without limitation, examples of suitable bromide-based brines include sodium bromide, calcium bromide, and zinc bromide. In addition, examples of formate-based brines include without limitation, sodium formate, potassium formate, and cesium formate.

### DESCRIPTION OF THE INVENTION

The present invention provides methods and processes forming a polymer mixture comprising an aqueous component and a polymer component and monitoring of the aqueous component and polymer mixture by refractometry-based methods. The present invention also provides industrial processes for adjusting the parameters affecting such production in real time. The present invention provides a method for use of refractometry to monitor refractive indices of aqueous components and polymer mixtures. These refractive indices directly correlate with TDS in feed liquids, polymer concentration, extent of dissolution, and viscosity of polymer mixtures.

Furthermore, the present invention provides for control of parameters affecting polymer dissolution and hydration, including but not limited to, polymer dose, mixing speed, mixing time, temperature, and pressure, and for a controller effectuating such control.

Furthermore, the present invention provides for monitoring the quality of the aqueous component used in the production of the polymer mixture via measurement of its refractive index.

Monitoring the batch-to-batch quality of the water used to form the diluted hydrated polymer composition is essential, and is ideally accomplished in real time. Impurities such as oil, grease, total suspended solids (TSS), total dissolved solids (TDS), hardness, and concentration of ions, including but not limited to, monovalent ions, halides (e.g., chloride), monovalent metal ions (e.g., alkali metals), and divalent metal ions can substantially affect the rate of formation of the hydrated polymer composition and the properties of the final diluted hydrated polymer composition.

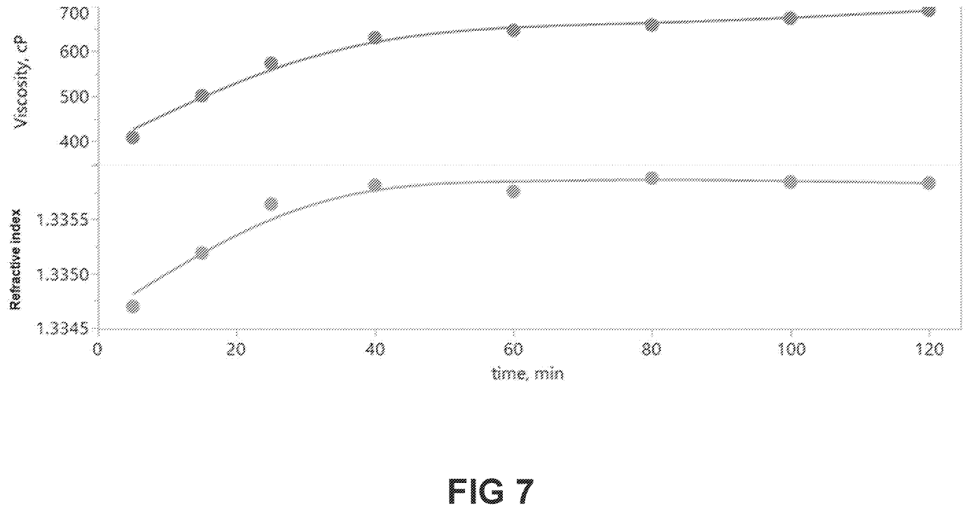

It was found that the refractive index of a water sample is dependent on the total dissolved solids (TDS). However, the inventors have surprisingly discovered that when a polymer is dissolved in different types of water, with different TDS levels, there is still a correlation between polymer content and refractive index, which includes a linear range. This result holds for different types of water as well as different polymers. Accordingly, the present invention specifies at least two refractometers, one placed to monitor the aqueous component before, and at least one after, polymer addition. It was surprisingly found, e.g., as shown from the results in FIG. 7, that there is a correlation between polymer mixture viscosity and refractive index. Since polymer mixture viscosity is an indication of polymer hydration, also called “activation”, the invention provides a means of monitoring polymer hydration in-line and in real time, unlike measurement of viscosity directly. By monitoring the refractive indices of the stream before, after, and optionally during polymer addition, the concentration and hydration of the resulting polymer mixture may be determined.

In general, the output signals from the refractometers and optionally other sensors are then used to determine in real time whether any parameters in the method should be altered, e.g., the output signals may be entered into dosing programs which are used to adjust the dosage of chemicals or other parameters used in the industrial process being conducted, e.g., the dosage of polymer, the mixing rate or duration, temperature, or pressure withing the mixing vessel.

A first refractometer on the liquid (water) line may be placed to record background signal. Due to changes in water quality, e.g., the amount of oil, organics and other dissolved solids the signal of the first refractometer changes. To correlate changes in outlet of hydration unit to polymer concentration, the background signal should be subtracted from signal of the second refractometer.

A common feature of water treatment is the addition of polymers as coagulants and/or flocculants. When properly prepared, these compounds can greatly facilitate the coagulation and/or flocculation process. Preparation of polymers typically involves dilution or dissolution of the polymer in an aqueous solution, possibly followed by “aging” or “maturing” in order to allow the polymer to fully hydrate or “activate” before addition to the process stream. For maximum efficacy, this polymer mixture must be of the correct concentration and the polymer must be sufficiently hydrated in order to interact efficiently with the components of the process stream. Another example is enhanced oil recovery where the polymer solution need to meet certain viscosity level to push oil out of formation (reservoir).

Monitoring the formation of the polymer mixture during production is important for assuring its quality and effectiveness. Full hydration of the polymer is important for maximal efficacy, and is dependent on the size, charge, and charge density of the polymer as well as the ionic strength and pH of the aqueous solution. Hydration may be achieved by addition of an aqueous diluent, including but not limited to, fresh water, brine, sea water, process water, well water, surface water, produced water, or a combination thereof. The quality of the water used to form the polymer mixture, including factors such as total dissolved solids (TDS), relative hardness, and chloride concentration, affects the formation of the polymer mixture, and ideally is monitored in real time. The efficacy of water treatment polymers is dose-dependent and can decline with excessive polymer doses.

The cost of polymers is often a significant fraction of total water treatment expense. Therefore, preparing and dosing the polymer mixture to maximize the efficacy of the polymers and minimizing the cost is an important consideration. In addition, residual polymers in the treatment products are an environmental concern.

Polymers for water treatment come in a variety of forms. They include coagulants, which comprise agents that may typically destabilize colloidal dispersions to facilitate coagulation, a process of agglomerating colloidal particles into larger particles. Exemplary polymeric or organic coagulants may comprise a poly(diallyldimethyl ammonium chloride) (“polyDADMAC”) compound; an epipolyamine compound; a polymer that may comprise one or more quaternary ammonium groups, such as acryloyloxyethyltrimethylammonium chloride, methacryloyloxyethyltrimethylammonium chloride, methacrylamidopropyltrimethylammonium chloride, acrylamidopropyltrimethylammonium chloride, alfa and beta glucans, including but not limited to scleroglucan and schizophyllan; or mixtures thereof. In some embodiments, one or more inorganic coagulants may be added to the process stream in addition to one or more polymeric coagulants. An inorganic coagulant may, for example, reduce, neutralize or invert electrical repulsions between particles. Said inorganic coagulants may comprise but are not limited to inorganic salts such as aluminum chloride, aluminum sulfate, aluminum chlorohydrate, polyaluminum chloride, polyaluminum silica sulfate, lime, calcium chloride, calcium sulfate, magnesium chloride, sodium aluminate, various commercially available aluminum salt coagulants, or combinations thereof. In some embodiments, the coagulant may comprise a combination or mixture of one or more of any of the above or other coagulants.

Flocculants, or flocculating agents, are chemicals that promote flocculation by causing colloids and other suspended particles in liquids to aggregate, thereby forming a floc. Flocculants are generally used in water treatment processes to improve the sedimentation or filterability of small particles. For example, flocculants are used in water treatment processes to improve the sedimentation or filterability of small particles. Flocculants that have been used in treatments for dewatering mineral tailings and oil sands tailings include polyacrylamide polymer flocculants. Among synthetic polymers, those commonly used comprise poly(ethylene oxide) in the nonionic category, poly(diallyldimethylammoniumchloride) (polyDADMAC) in the cationic category, and polyacrylamide (PAM) and poly(styrenic sulfonic acid) in the anionic category. Acrylamide-based polymers, such as cationic emulsion polyacrylamide, are widely used as flocculants in wastewater treatment, and anionic dry polyacrylamides are widely used as flocculants in oil sands tailings treatment.

In addition, the polymers of the invention include a poly(propylene oxide), a polyacrylate, a poly(maleic acid), a poly(itaconic acid), a poly(diallyldimethylammoniumchloride), a polyvinyl pyrrolidone, a polyvinyl alcohol, a polyamine (copolymers of dimethylamine and epichlorohydrin), a polyamidoamine-epichlorohydrin copolymer, a polyethyleneimine, a polyethylene glycol, a carrageenan, an agar, an alginate, a guar gum, a locust bean gum, a gum tragacanth, a konjac glucomannan, a tara gum, a cassia gum, a gum arabic, a pectin, a starch, a xanthan gum, a gellan gum, a pullulan, a curdlan, a dextran, a welan gum, a rhamsan, a succinoglycan, a cellulose gum, a modified starch, a propylene glycol alginate, a modified guar gum, chitosan, a polyphosphonate, a copolymer, a terpolymer, a linear polymer, a branched polymer, a cross-linked polymer, a cationic polymer, an anionic polymer, a non-ionic polymer, a grafted polymer, alfa and beta glucans, including but not limited to scleroglucan and schizophyllan, or a modified polymer.

In some embodiments, the polymer flocculant can be a homopolymer or a copolymer. The term “copolymer” refers to any polymer having more than one type of monomer and may include, for example, terpolymers. Preferably, the copolymer includes two types of monomers. Preferably, the copolymer is a random copolymer.

The monomers of the homopolymer or copolymer may be selected from the group consisting of non-ionic monomers, anionic monomers, and cationic monomers.

In some embodiments, the non-ionic monomer is selected from the group consisting of acrylamide and methacrylamide. Preferably, the non-ionic monomer is acrylamide.

In some embodiments, the anionic monomer is selected from the group consisting of acrylic acid, methacrylic acid, itaconic acid, crotonic acid, fumaric acid, and acrylamido tertiary butyl sulfonic acid (ATBS). Preferably the anionic monomer is acrylic acid or ATBS.

In some embodiments, the cationic monomer is dimethylaminoethyl acrylate-methyl chloride (Q9) aka acryloyloxy ethyl trimethyl ammonium chloride (AETAC) and salts thereof.

When the polymer includes an anionic or cationic monomer, the polymer may further comprise one or more counterions. For example, when the polymer includes an anionic monomer, the counterion may be sodium, calcium or magnesium, preferably sodium or calcium.

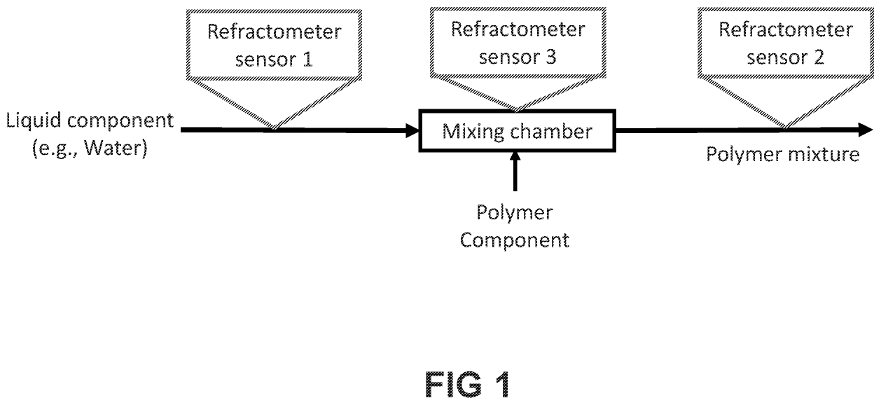

In some exemplary embodiments, the method is schematically depicted in FIGS. 1-4.

The present invention provides methods and processes forming a polymer mixture comprising an aqueous component and a polymer component and monitoring of the aqueous component and the polymer mixture in real-time by refractometry-based methods.

In one aspect, there is provided a method for forming a hydrated polymer composition comprising an aqueous component and a polymer component comprising one or more polymers, which method comprises the monitoring of polymer content by refractometry during the method, the method comprising:
(a) measuring a first refractive index of the aqueous component with a refractometer prior to addition of the polymer component;
(b) contacting an amount of said polymer component with said aqueous component optionally within a mixing tank or a feed pipe to create said hydrated polymer composition;
(c) measuring a second refractive index of said hydrated polymer composition, optionally after it is no longer in contact with the mixing tank or the feed pipe, with the refractometer used in the first refractive index measurement or a different refractometer; and
(d) optionally, measuring a third refractive index of said aqueous component and said polymer component within the mixing tank or feed pipe, with the refractometer used in the first and/or second refractive index measurements or a different refractometer,
wherein steps (a) to (c) or (a) to (d) are effected concurrently or successively.

In one embodiment, the polymer component comprises one or more of the following:
(a) an emulsion polymer comprising a dispersion of water, greater than about 10% by weight said one or more polymers, one or more emulsifier surfactants, and one or more inverting surfactants dispersed in one or more hydrophobic liquids having a boiling point at least about 100 °C, which emulsion polymer is inverted when contacted with said aqueous component to form said hydrated polymer composition;
(b) a dry polymer comprising said one or polymers formulated as granules, as a dry powder, or a combination thereof, further comprising a residual amount of water and optionally buffers, anti-caking additives, anti-dusting agents, and one or more surfactants to facilitate dissolution, which dry polymer is dissolved when contacted with said aqueous component to form said hydrated polymer composition; or
(c) an aqueous stock polymer solution comprising said one or more polymers dissolved in water at a concentration ranging from 500 to 800,000 ppm, 3000 to 100,000 ppm, 4000 to 40,000 ppm, 4000 to 10,000 ppm, from 4000 to 6000 ppm, or from 4500 to 5500 ppm, which aqueous stock polymer solution is diluted when contacted with said aqueous component to form said hydrated polymer composition.

In another embodiment, (a) the one or more emulsifier surfactants are selected from the group consisting of sorbitan esters, ethoxylated fatty alcohols with 1 to 4 ethyleneoxy groups, phthalic esters, fatty acid glycerides, glycerin esters, sorbitan monooleate, the reaction product of oleic acid with isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, and the ethoxylated versions of the foregoing containing 1 to 10 moles of ethylene oxide per mole of the basic emulsifier, modified polyester surfactants, anhydride substituted ethylene copolymers, N,N-dialkanol substituted fatty amides, tallow amine ethoxylates, and mixtures or combinations of the foregoing;
(b) the one or more inverting surfactants are selected from the group consisting of ethoxylated amine compounds, ethoxylated fatty acid compounds, and alkyl polyethyleneglycol ether carboxylic acid compounds, alkyl polyglycol ether carboxylic acid compounds, and salts or esters thereof, ethoxylated alcohols, alcohol ethoxylates, ethoxylated esters of sorbitan, ethoxylated esters of fatty acids, ethoxylated fatty acid esters, ethoxylated esters of sorbitol and fatty acids, nonionic surfactants comprising a hydrocarbon group and a polyalkylenoxy group of sufficient hydrophilic nature, nonionic surfactants of the general formula R1-O—(CH(R2)-CH2-O)nH (I), wherein R1 is a C8-C22-hydrocarbon group, n is a number of 2:4, and R2 is H, methyl or ethyl, and at least 50% of the groups R2 are H, polyethoxylates based on C10-C18-alcohols, tridecylalcohol ethoxylates comprising from 4 to 14 ethylenoxy groups, tridecyalcohol.8 EO, or C12/14 fatty alcohol ethoxylates, C12/14.8 EO, modified polyester surfactants, anhydride substituted ethylene copolymers, N,N-dialkanol substituted fatty amides, tallow amine ethoxylates, and mixtures and combinations of the forgoing; and
(c) the one or more hydrophobic liquids having a boiling point at least about 100 °C is selected from the group consisting of paraffin hydrocarbons, naphthene hydrocarbons, aromatic hydrocarbons, olefins, oils, stabilizing surfactants, and mixtures or combinations of the foregoing.
In another embodiment, (a) said hydrated polymer composition is formed in a polymer mixing tank, in a polymer aging tank, in a polymer hydration unit, in a turbulent feed line or pipe, in a static feed line or pipe, in a polymer make down or make up unit, on-site, in a remote setting, or in an industrial or laboratory setting;
(b) said aqueous component comprises water, produced water, fresh water, salt water, brine, sea water, ground water, surface water, or reclaimed water, wastewater, municipal wastewater, industrial wastewater, paper or pulp wastewater, storm wastewater, mining tailings, oil sands tailings, sludge, papermaking whitewater, or a combination thereof;
(c) said one or more polymers comprise anionic, cationic, amphoteric, or non-ionic (neutral) polymers;
(d) said one or more polymers comprises one or more copolymers, terpolymers, linear polymers, branched polymers, cross-linked polymers, cationic polymers, anionic polymers, non-ionic polymers, grafted polymers, modified polymers, or any combination of the foregoing;
(e) said one or more polymers comprises one or more copolymers, terpolymers, linear polymers, branched polymers, cross-linked polymers, cationic polymers, anionic polymers, non-ionic polymers, grafted polymers, or modified polymers optionally selected from anionic, cationic or neutral polyacrylamide polymers and copolymers, including but not limited to, Acrylamide/Acrylic Acid copolymers, Acrylamide/acrylamido tertiary butyl sulfonic acid (ATBS aka AMPS) copolymers, Acrylamide/Acrylic Acid/ATBS terpolymer, Acrylamide/acryloyloxy ethyl trimethyl ammonium chloride (AETAC) cationic polyacrylamide copolymers, partially hydrolyzed acrylamide, or other acrylamide containing polymers, poly(ethylene oxide polymers), poly(propylene oxide polymers), polyacrylate polymers, a poly(maleic acid) polymers, poly(itaconic acid) polymers, poly(diallyldimethylammonium chloride) polymers, polyvinyl pyrrolidone polymers, polyvinyl alcohol polymers, poly(styrenic sulfonic acid) polymers, polyamine polymers and copolymers such as copolymers of dimethylamine and epichlorohydrin), polyamidoamine-epichlorohydrin copolymers, polyethyleneimine polymers, polyethylene glycols, cellulose and cellulose derivative comprising polymers such as carboxymethylcellulose (CMC), Methylcellulose (MC), ethylcellulose (EC), hydroxypropylcellulose (HPC), hydroxyethylcellulose (HEC), and hydroxypropylmethylcellulose (HPMC) polymers, carrageenans, agars, alginates, guar gums, locust bean gums, a gum tragacanth, a konjac glucomannan, a tara gum, a cassia gum, a gum arabic, a pectin, a starch, a xanthan gum, a gellan gum, a pullulan, a curdlan, a dextran, a welan gum, a rhamsan, a succinoglycan, cellulose gum, a modified starch, a propylene glycol alginate, modified guar gums, chitosans, polyphosphonates, and alfa and beta glucans, including but not limited to scleroglucan and schizophyllan;
(f) said polymer component comprises a plurality of different polymers;
(g) the molecular weight of said one or more polymers ranges from 500 Da to 200,000,000 Da, or from 10,000 Da to 100,000,000 Da, or from 10,000 Da to 50,000,000 Da or from 10,000 Da to 20,000,000 Da, or from 10,000 Da to 10,000,000 Da or from 10,000 Da to 1,000,000 Da or from 10,000 Da to 500,000 Da or from 10,000 Da to 100,000 Da;
(h) the concentration after mixing of said one or more polymers in said hydrated polymer composition is between 1 ppm and 800,000 ppm or between 1 and 300,000 ppm; or between 1 and 100,000 ppm; or between 1 and 20,000 ppm; or between 1 and 10,000 ppm; or between 1 and 1,000 ppm; or
(i) any combination of (a) to (h).

The one or more polymers may comprise an acrylamide-containing polymer comprising acrylamide or partially hydrolyzed acrylamide and one or more anionic monomers, an acrylamide-containing polymer comprising acrylamide or partially hydrolyzed acrylamide and one or more cationic monomers, or an acrylamide-containing polymer comprising acrylamide or partially hydrolyzed acrylamide and one or more anionic monomers and one or more cationic monomers.

In one embodiment, (a) said one or more polymers comprise an acrylamide-containing polymer comprising acrylamide, acrylic acid or any salt thereof, and optionally one or more additional cationic and/or anionic monomers;

(b) said one or more polymers comprise an acrylamide-containing polymer comprising acrylamide, acrylamido tertiary butyl sulfonic acid (ATBS) or any salt thereof, and optionally one or more additional cationic and/or anionic monomers; or

(c) said one or more polymers comprise an acrylamide-containing polymer comprising acrylamide, acrylic acid or any salt thereof, acrylamido tertiary butyl sulfonic acid (ATBS) or any salt thereof, and optionally one or more additional cationic and/or anionic monomers.

In some embodiments the method comprises one or more of the following,
(a) the method is effected continuously or periodically;
(b) the method is effected in an in-line manner on site, remotely on site, at a sampling point, or in a lab;
(c) there is a correlation between the second refractive index and a concentration of said one or more polymers in said hydrated polymer composition;
(d) there is a correlation between the second refractive index and a viscosity of said hydrated polymer composition;
(e) in (c) or (d) the correlation between the second refractive index and the concentration of said one or more polymers in said hydrated polymer composition is independent of the total dissolved solids (TDS) in mg/kg or the relative hardness in mol % of the aqueous component;
(f) said first, second, and third refractive indices are measured in real time;
(g) the results are electronically transmitted to another site, to a graphical user interface, to a controller, or to a feedback loop;
(h) said first refractive index is compared to said second refractive index or to said third refractive index to determine at least one property of said hydrated polymer composition; optionally wherein said at least one property comprises concentration, amount of hydration, a percent dissolution of said polymer, or combination thereof;
(i) said at least one property is determined more rapidly compared to an industrial analysis method comprising on-site sampling followed by laboratory analysis of concentration, viscosity, amount of hydration, or percent dissolution of said polymer;
(j) a first flow rate of said aqueous component or a second flow rate of said polymer component is adjusted based on the values of said first refractive index, said second refractive index and/or said third refractive index;
(k) said first refractive index and/or said second refractive index positively correlate with measurements of the viscosity of said aqueous component and/or said hydrated polymer composition;
(l) the hydrated polymer composition is optionally subjected to a secondary dilution step, wherein the secondary dilution step comprises addition of the hydrated polymer composition to a process water stream to form a second hydrated polymer composition;
(m) the hydrated polymer composition or the second hydrated polymer composition is used in an industrial application including but not limited to mining, petroleum extraction, enhanced oil recovery, oil sands processing, oil sands tailings treatment, paper or pulp manufacture, industrial water treatment, municipal water treatment, surface water treatment, storm water treatment, and agricultural waste treatment; or
(n) a combination of one or more of (a) to (m).

In another aspect, there is provided a method for forming a hydrated polymer composition comprising a first aqueous component and a polymer component comprising one or more polymers, which method comprises real-time monitoring of polymer content by refractometry during the method, the method comprising:
(a) measuring in real time a first refractive index of an aqueous inlet stream comprising the first aqueous component with a first refractometer, wherein said first refractive index is measured prior to contacting the first aqueous component with the polymer component;
(b) feeding said first aqueous inlet stream into a mixing tank or pipe at a first feed rate and feeding a polymer inlet stream comprising the polymer component into the mixing tank or pipe at a second feed rate;
(c) allowing the first aqueous component to contact the polymer component, thereby forming an initial hydrated polymer composition;
(d) agitating said initial hydrated polymer composition at an agitation rate for an agitation time;
(e) allowing the hydrated polymer composition to exit the mixing tank or pipe at an outlet rate as an outlet stream comprising the hydrated polymer composition and measuring in real time a second refractive index of the outlet stream with a second refractometer;
(f) optionally, measuring a third refractive index of the initial hydrated polymer composition in real time with a third refractometer, wherein said third refractometer is located inside the mixing tank or pipe and in contact with the initial hydrated polymer composition;
wherein steps (a)-(f) are effected concurrently, successively, or in any order.

In one embodiment, the polymer component comprises one of the following:
(a) an emulsion polymer comprising a dispersion of water, greater than about 10% by weight said one or more polymers, one or more emulsifier surfactants, and one or more inverting surfactants dispersed in one or more hydrophobic liquids having a boiling point at least about 1000 C, which emulsion polymer is inverted when contacted with said aqueous component to form said hydrated polymer composition;
(b) a dry polymer comprising said one or polymers formulated as granules, as a dry powder, or a combination thereof, further comprising a residual amount of water and optionally buffers, anti-caking additives, anti-dusting agents, and one or more surfactants to facilitate dissolution, which dry polymer is dissolved when contacted with said aqueous component to form said hydrated polymer composition; or
(c) an aqueous stock polymer solution comprising said one or more polymers dissolved in water at a concentration ranging from 500 to 800,000 ppm, 3000 to 100,000 ppm, 4000 to 40,000 ppm, 4000 to 10,000 ppm, from 4000 to 6000 ppm, or from 4500 to 5500 ppm, which aqueous stock polymer solution is diluted when contacted with said aqueous component to form said hydrated polymer composition.

In one embodiment, (a) the one or more emulsifier surfactants are selected from the group consisting of sorbitan esters, ethoxylated fatty alcohols with 1 to 4 ethyleneoxy groups, phthalic esters, fatty acid glycerides, glycerin esters, sorbitan monooleate, the reaction product of oleic acid with isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, and the ethoxylated versions of the foregoing containing 1 to 10 moles of ethylene oxide per mole of the basic emulsifier, modified polyester surfactants, anhydride substituted ethylene copolymers, N,N-dialkanol substituted fatty amides, tallow amine ethoxylates, and mixtures or combinations of the foregoing;
(b) the one or more inverting surfactants are selected from the group consisting of ethoxylated amine compounds, ethoxylated fatty acid compounds, and alkyl polyethyleneglycol ether carboxylic acid compounds, alkyl polyglycol ether carboxylic acid compounds, and salts or esters thereof, ethoxylated alcohols, alcohol ethoxylates, ethoxylated esters of sorbitan, ethoxylated esters of fatty acids, ethoxylated fatty acid esters, ethoxylated esters of sorbitol and fatty acids, nonionic surfactants comprising a hydrocarbon group and a polyalkylenoxy group of sufficient hydrophilic nature, nonionic surfactants of the general formula R1-O—(CH(R2)-CH2-O)nH (I), wherein R1 is a C8-C22-hydrocarbon group, n is a number of 2:4, and R2 is H, methyl or ethyl, and at least 50% of the groups R2 are H, polyethoxylates based on C10-C18-alcohols, tridecylalcohol ethoxylates comprising from 4 to 14 ethylenoxy groups, tridecyalcohol.8 EO, or C12/14 fatty alcohol ethoxylates, C12/14.8 EO, modified polyester surfactants, anhydride substituted ethylene copolymers, N,N-dialkanol substituted fatty amides, tallow amine ethoxylates, and mixtures and combinations of the forgoing; and
(c) the one or more hydrophobic liquids having a boiling point at least about 100 °C is selected from the group consisting of paraffin hydrocarbons, naphthene hydrocarbons, aromatic hydrocarbons, olefins, oils, stabilizing surfactants, and mixtures or combinations of the foregoing.

In some embodiments, the method comprises one or more of the following: (i) the first refractometer is positioned in contact with the first aqueous component prior to entering the mixing tank or pipe and the second refractometer is positioned in contact with the hydrated polymer composition after exiting the mixing tank or pipe;
(ii) a third refractive index of the initial hydrated polymer composition is measured in real time with a third refractometer, wherein said third refractometer is located inside the mixing tank or pipe and in contact with the initial hydrated polymer composition;
(iii) said first refractive index is used to determine a background signal and a real-time property of the inlet stream, including but not limited to, a total dissolved solids (TDS) in mg/kg and a relative hardness in mol %;
(iv) at least one of said real-time properties of the inlet stream is adjusted to remain within predetermined limits based on said first refractive index, optionally wherein said first aqueous component of said inlet stream is modified by addition of a second aqueous component to form a partially purified inlet stream based on any combination of said real-time properties of the inlet stream, wherein the TDS, total polymer concentration, relative hardness, and/or viscosity of the second aqueous component is less than the first aqueous component;
(v) said first refractive index is subtracted from said second refractive index to determine a real-time property of the outlet stream selected from the group of properties consisting of a total polymer concentration, a viscosity, an amount of polymer hydration, a percent of polymer dissolution, or any combination thereof;
(vi) a first parameter of mixing is adjusted based on any combination of said real-time properties of the outlet stream selected from the group of parameters consisting of the first feed rate, the second feed rate, the feed rate of said second aqueous component, the agitation rate, the agitation time, the temperature of the mixing tank or pipe, the outlet feed rate, the TDS of said first aqueous component, the pH, or any combination thereof;
(vii) said first refractive index is subtracted from said third refractive index to determine a real-time property of the initial hydrated polymer composition selected from the group of properties consisting of a total polymer concentration, a viscosity, an amount of polymer hydration, a percent of polymer dissolution, or any combination thereof;
(viii) a second parameter of mixing is adjusted based on any combination of said real-time properties of the initial hydrated polymer composition selected from the group of properties consisting of the first feed rate, the second feed rate, the agitation rate, the agitation time, the temperature of the mixing tank or pipe, the outlet feed rate, or any combination thereof;
(ix) if the first, second, and/or third refractive indices deviates from a predetermined upper or lower threshold an alarm is triggered and/or a corrective response is triggered to return the refractive index to within said predetermined upper or lower threshold;
(x) the mixing tank or pipe is heated or cooled based on said real-time property of the initial hydrated polymer composition, said real-time property of the outlet stream, or a combination thereof; or
(xi) any combination of (i) to (x).

In some embodiments, (a) the method is effected continuously or periodically;
(b) the method is effected in a polymer hydration plant, in an on-site field application, or in a lab;
(c) said first aqueous inlet stream and said polymer inlet stream are added to the mixing tank or pipe simultaneously or separately;
(d) the mixing tank or pipe comprises a static tank, a feed pipe, a feed pipe with turbulent flow, a mechanical mixer, a static mixer, a magnetic agitator, a hydrodynamic mixer, a rocking tank, a hydraulic mixer, a polymer hydration unit, a polymer make down or make up unit, an agitator with mechanical stirrer, or any combination of the foregoing;
(e) the method is optionally run in an industrial or lab setting outside of a polymer hydration unit;
(f) said first refractive index, said second refractive index, said third refractive index, said real-time property of the inlet stream said real-time property of the initial hydrated polymer composition, and said real-time property of the outlet stream are measured periodically or continuously;
(g) said inlet stream, said first parameter of mixing, and/or said second parameter of mixing is modified once, periodically, or continuously;
(h) any or all of the refractometry results or real time properties are electronically transmitted to another site, to a graphical user interface, to a controller, and/or to a feedback loop;
(i) the method is run under pressure, wherein said pressure is greater than or equal to atmospheric pressure, further wherein said pressure ranges from 0.2 to 250 bar, or from 0.2 to 100 bar, or from 0.2 to 50 bar, or from 0.2 to 10-200 bar, or from 0.2 to 5 bar, typically 1-3 bar and more typically 1.5 to 2.0 bar; or
(i) any combination of (a)-(i).

In some embodiments,
(a) the first aqueous component comprises water, produced water, fresh water, salt water, brine, sea water, ground water, surface water, or reclaimed water, wastewater, municipal wastewater, industrial wastewater, paper or pulp wastewater, storm wastewater, mining tailings, oil sands tailings, sludge, papermaking whitewater, or a combination thereof;
(b) the first aqueous component comprises a total dissolved solids ranging from 0-500,000 mg/kg, or from 10-100,000 mg/kg, or from 10-50,000 mg/kg;
(c) the first aqueous component comprises a relative hardness ranging from 0.01-50 mol %, or from 0.1-10 mol %;
(d) said one or more polymers comprise one or more anionic, cationic, amphoteric, or non-ionic (neutral) polymers;
(e) said one or more polymers comprise one or more copolymers, terpolymers, linear polymers, branched polymers, cross-linked polymers, cationic polymers, anionic polymers, non-ionic polymers, grafted polymers, modified polymers, or any combination of the foregoing;
(f) said one or more polymers comprise one or more copolymers, terpolymers, linear polymers, branched polymers, cross-linked polymers, cationic polymers, anionic polymers, non-ionic polymers, grafted polymers, or modified polymers optionally selected from anionic, cationic or neutral polyacrylamide polymers and copolymers, including but not limited to, Acrylamide/Acrylic Acid copolymers, Acrylamide/acrylamido tertiary butyl sulfonic acid (ATBS aka AMPS) copolymers, Acrylamide/Acrylic Acid/ATBS terpolymers, Acrylamide/acryloyloxy ethyl trimethyl ammonium chloride (AETAC) cationic polyacrylamide copolymers, partially hydrolyzed acrylamide, or other acrylamide containing polymers, poly(ethylene oxide polymers), poly(propylene oxide polymers), polyacrylate polymers, a poly(maleic acid) polymers, poly(itaconic acid) polymers, poly(diallyldimethylammonium chloride) polymers, polyvinyl pyrrolidone polymers, polyvinyl alcohol polymers, poly(styrenic sulfonic acid) polymers, polyamine polymers and copolymers such as copolymers of dimethylamine and epichlorohydrin), polyamidoamine-epichlorohydrin copolymers, polyethyleneimine polymers, polyethylene glycols, cellulose and cellulose derivative comprising polymers such as carboxymethylcellulose (CMC), Methylcellulose (MC), ethylcellulose (EC), hydroxypropylcellulose (HPC), hydroxyethylcellulose (HEC), and hydroxypropylmethylcellulose (HPMC) polymers, carrageenans, agars, alginates, guar gums, locust bean gums, a gum tragacanth, a konjac glucomannan, a tara gum, a Cassia gum, a gum arabic, a pectin, a starch, a xanthan gum, a gellan gum, a pullulan, a curdlan, a dextran, a welan gum, a rhamsan, a succinoglycan, cellulose gum, a modified starch, a propylene glycol alginate, modified guar gums, chitosans, polyphosphonates, and alfa and beta glucans, including but not limited to scleroglucan and schizophyllan;
(g) said polymer component comprises a plurality of different polymers;
(h) the molecular weight of said one or more polymers ranges from 500 Da to 200,000,000 Da, or from 10,000 Da to 100,000,000 Da, or from 10,000 Da to 50,000,000 Da or from 10,000 Da to 20,000,000 Da, or from 10,000 Da to 10,000,000 Da or from 10,000 Da to 1,000,000 Da or from 10,000 Da to 500,000 Da or from 10,000 Da to 100,000 Da; and
(i) the concentration after mixing of said one or more polymers in said hydrated polymer composition is between 1 ppm and 800,000 ppm or between 1 and 300,000 ppm; or between 1 and 100,000 ppm; or between 1 and 20,000 ppm; or between 1 and 10,000 ppm; or between 1 and 1,000 ppm; or
(j) any combination of (a) to (i).

In some embodiments, (a) said one or more polymers comprise an acrylamide-containing polymer comprising acrylamide, acrylic acid or any salt thereof, and optionally one or more additional cationic and/or anionic monomers;
(b) said one or more polymers comprise an acrylamide-containing polymer comprising acrylamide, acrylamido tertiary butyl sulfonic acid (ATBS) or any salt thereof, and optionally one or more additional cationic and/or anionic monomers; or
(c) said one or more polymers comprise an acrylamide-containing polymer comprising acrylamide, acrylic acid or any salt thereof, acrylamido tertiary butyl sulfonic acid (ATBS) or any salt thereof, and optionally one or more additional cationic and/or anionic monomers.

In some embodiments, (a) there is a positive correlation between said second refractive index and the amount of hydration of the polymer component in said hydrated polymer composition;
(b) there is a positive correlation between said second refractive index and the percent dissolution of the polymer component in said hydrated polymer composition;
(c) there is a positive correlation between said third refractive index and the amount of hydration of the polymer component in said initial hydrated polymer composition;
(d) there is a positive correlation between said third refractive index and the percent dissolution of the polymer component in said initial hydrated polymer composition;
(e) there is a correlation between said second refractive index and the final concentration of said polymer component in said hydrated polymer composition;
(f) there is a correlation between said second refractive index and the viscosity of said hydrated polymer composition;
(g) there is a correlation between said third refractive index and the concentration of said polymer component in said initial hydrated polymer composition;
(h) there is a correlation between said third refractive index and the viscosity of said initial hydrated polymer composition; or
(i) a combination of one or more of (a) to (h).

In some embodiments, (a) the hydrated polymer composition is optionally subjected to a secondary dilution step, wherein the secondary dilution step comprises addition of the hydrated polymer composition to a process water stream to form a second hydrated polymer composition;
(b) the hydrated polymer composition or the second hydrated polymer composition is used in an industrial process relating to any phase of the oil sand mining processes including, but not limited to, recovery, extraction, refining, dewatering, and waste treatment; enhanced oil recovery, any mineral mining or mineral processing operation, sludge dewatering; pulp and papermaking, municipal wastewater treatment, oil and gas fracking, and any industrial process which requires polymer hydration or polymer inversion;
(c) said real-time property is determined more rapidly compared to an industrial analysis method comprising on-site sampling followed by laboratory analysis of concentration, viscosity, amount of hydration, or percent dissolution of said polymer; and/or
(d) said method optionally comprises on-site sampling of one or more of said aqueous inlet stream, said initial hydrated polymer composition, and said outlet stream followed by laboratory validation of said first refractive index, said second refractive index, and said third refractive index.

The examples provided herein are for illustrative purposes so that the invention may be more fully understood. These examples should not be construed as limiting the invention in any way.

### Examples

The following examples are presented for illustrative purposes only and are not intended to be limiting.

### Materials

Polymer characteristics are listed in Table 1. Chemical properties of field water, and synthetic brine are listed in Tables 2-4.

TABLE 1
Characteristics of polymers.

| | Molecular | Polymer | |
|---|---|---|---|
| Polymer | Weight | Charge | Polymer Type |
| Polymer 1 | Low | Low | Hydrolyzed polyacrylamide |
| Polymer 2 | Very High | High | Hydrolyzed polyacrylamide |
| Polymer 3 | High | Low | Hydrolyzed polyacrylamide |
| Polymer 4 | Very low | Low | Copolymer of acrylamide |
| | | | and acrylic acid |

TABLE 2
Composition of water samples in which polymers were dissolved
(ppm indicates mg/kg).

| | | Relative | | | | | | | | | | | | |
|---|---|---|---|---|---|---|---|---|---|---|---|---|---|---|
| | TDS | hardness | Na | K | Ca | Mg | Ba | Sr | Fe | Mn | Cl | SO₄ | HCO₃ | NO₃ |
| Water | ppm | mol % | ppm | ppm | ppm | ppm | ppm | ppm | ppm | ppm | ppm | ppm | ppm | ppm |
| Field | 2424 | 7.6 | 770 | 3 | 97 | 8 | <0.1 | 0.5 | <0.1 | 0.34 | 1400 | <10 | — | 19 |
| water | | | | | | | | | | | | | | |
| Synthetic | 2812 | 7.1 | 945 | 2 | 112 | 9 | — | — | — | — | 1598 | — | 146 | — |
| brine | | | | | | | | | | | | | | |

TABLE 3
Composition of aqueous brine samples in which
polymers were dissolved (ppm indicates mg/kg).

| | | Relative | | | | | |
|---|---|---|---|---|---|---|---|
| | TDS | hardness | Na | K | Ca | Mg | Cl |
| Water | ppm | mol % | ppm | ppm | ppm | ppm | ppm |
| Synthetic brine 1 | 23635 | 2.4 | 8840 | 84 | 256 | 75 | 14380 |
| Synthetic brine 2 | 2812 | 7.1 | 945 | 2 | 112 | 9 | 1598 |

TABLE 4
Composition of water samples in which polymer was
dissolved (ppm indicates mg/kg).

| | | Relative | | | | | | | |
|---|---|---|---|---|---|---|---|---|---|
| | TDS | hardness | Na | K | Ca | Mg | Cl | SO₄ | HCO₃ |
| Water | ppm | mol % | ppm | ppm | ppm | ppm | ppm | ppm | ppm |
| Field | 2420 | 2.0 | 756 | 16 | 11 | 10 | 662 | 26 | 940 |
| water | | | | | | | | | |

### Example 1: Refractometer Sensor and Multichannel Interface Arrangement

### Refractometer Sensors

Refractometer sensors were placed upstream and downstream of a polymer hydration unit as shown in FIG. 1. Refractometer sensor 1 was installed on the incoming liquid feed line to record baseline refractometry data in real time from the incoming aqueous component. Refractometer sensor 2 was installed after the mixing chamber of a hydration unit in order to record refractometry data in real time of the polymer mixture after exiting the mixing chamber. Refractometer 3 may optionally be placed inside the mixing chamber in order to record refractometry data in real time of the polymer mixture during agitation. Refractometers 1-3 may be placed in contact with the aqueous component or polymer mixture by any means suitable to obtain a stable reproducible signal. Refractometers may be completely submerged or may be positioned in contact with the aqueous component and polymer mixture.

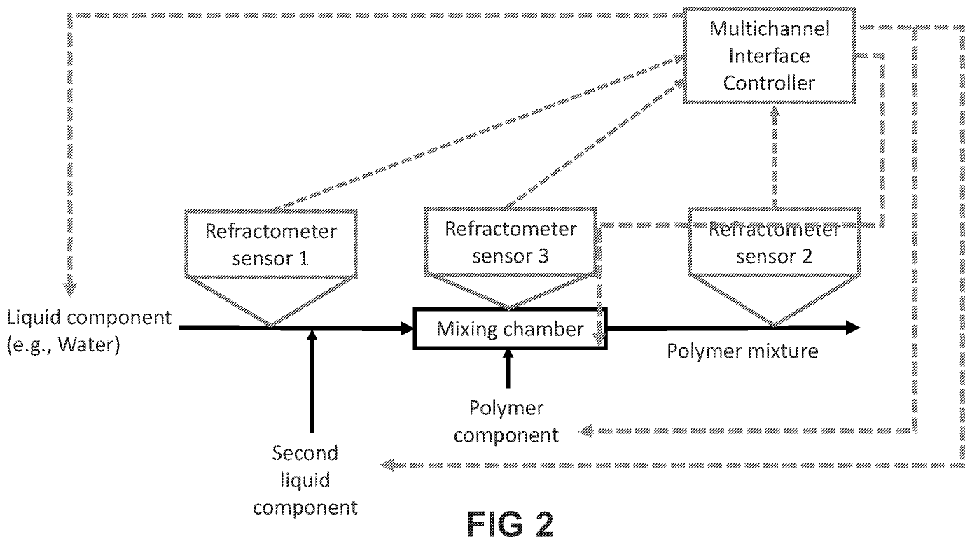

One of many possible arrangements for refractometer placement and data flow from refractometers to and from a multichannel interface controller is shown in FIG. 2. Refractometry data from refractometers 1-3 is transmitted to and from the multichannel interface controller via data cables, Bluetooth, or other radio frequency based means of data transmission. Refractometry data is baseline-corrected and compared to a standard curve to determine feed water quality, extent of polymer dissolution, polymer hydration, polymer concentration, and/or polymer viscosity. Control signals are then sent from the multichannel interface controller to adjust the feed rate of incoming aqueous component, the agitation rate and agitation time of the forming polymer mixture, and the outlet rate of the polymer mixture. Refractometer signals may also be used to adjust the feed composition of aqueous component by blending a second feed aqueous component into the first aqueous component upstream of the mixing chamber.

The refractometer sensors respond to changes in refractive index of the polymer concentration. Refractometer sensor can be used as an inline or lab device for monitoring or measuring polymer concentration. The basis of this technique is that during the dissolution process, the polymer concentration increases continuously in the solvent, and this concentration can be measured by the refractive index. Changes in feed water quality used for polymer dissolution can also be detected.

Refractive index measurement or refractometry is the method of measuring the refractive index of a substance and composition, purity, or extent of dissolution. Refractometry is a technique that measures how light is refracted when it passes through a given substance. Standard refractometers measure the extent of light refraction (as part of a refractive index) of transparent substances in either a liquid or solid-state; this is then used in order to identify a liquid sample, analyze the sample's purity, and determine the amount or concentration of dissolved substances within the sample. As light passes through the liquid from the air it will slow down and create a ‘bending’ illusion, the severity of the ‘bend’ will depend on the amount of substance dissolved in the liquid.

A refractometer is a laboratory or field device for the measurement of an index of refraction (refractometry). The index of refraction is then calculated from the observed refraction angle using Snell's law. For mixtures, the index of refraction then allows to determine the concentration using mixing rules such as the Gladstone-Dale relation and Lorentz-Lorenz equation. There are four main types of refractometers: traditional handheld refractometers, digital handheld refractometers, laboratory or Abbe refractometers (named for the instrument's inventor and based on Ernst Abbe's original design of the ‘critical angle’), and inline process refractometers. For process scale polymer hydration, an inline process refractometer is preferred. For laboratory-scale or portable monitoring of polymer hydration, any of the aforementioned types of refractometers may be used.

Snell's Law, also known as The Law of Refraction, is used to determine the direction of light rays through refractive media with varying indices of refraction. The indices of refraction of the media, labeled n₁, n₂, and so on, are used to represent the factor by which a light ray's speed decreases when traveling through a refractive medium, such as glass or water, as opposed to its velocity in a vacuum. As light passes the border between media, depending upon the relative refractive indices of the two media, the light will either be refracted to a lesser angle, or a greater one. These angles are measured with respect to the normal line, represented perpendicular to the boundary. In the case of light traveling from air into water, light would be refracted towards the normal line, because the light is slowed down in water; light traveling from water to air would refract away from the normal line.

Snell's law, which may be represented as nisin θ₁=n₂ sin θ₂, states that, for a given pair of media, the ratio of the sines of the angle of incidence θ₁ and angle of refraction θ₂ is equal to the ratio of phase velocities (v₁/v₂) in the two media, or equivalently, to the refractive indices (n₂/n₁) of the two media. When the light or other wave involved is monochromatic, that is, of a single frequency, Snell's law can also be expressed in terms of a ratio of wavelengths in the two media, λ₁, λ₂.

Benefits of the using refractometry to monitor dilution of polymer solutions include (i) real time monitoring of polymer concentration, hydration, dissolution, viscosity; (ii) real time monitoring of polymer mixtures throughout hydration, at outlet of hydration and after dilution, (iii) real time monitoring of feed water quality, (iv) quicker diagnostic and response time compared presently used industrial methods, (v) determination of accurate polymer concentration using a calibration curve; (vi) quick and easy analysis to compare expected polymer concentration with actual concentration; (vii) direct correlation with polymer viscosity data; (viii) measurements may be performed in laboratory settings using a lab-scale device, on site at a sampling point using a portable measurement device, and in-process using a process integrated device.

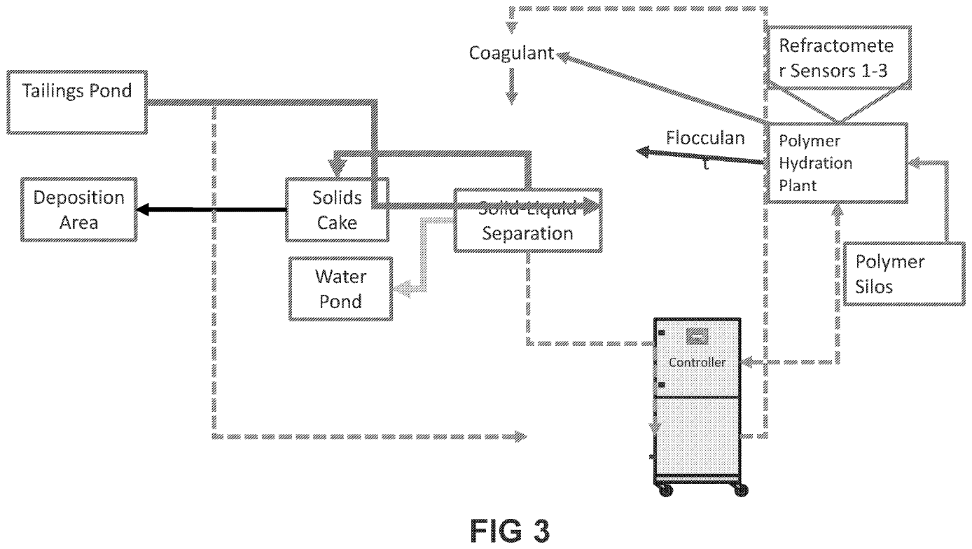

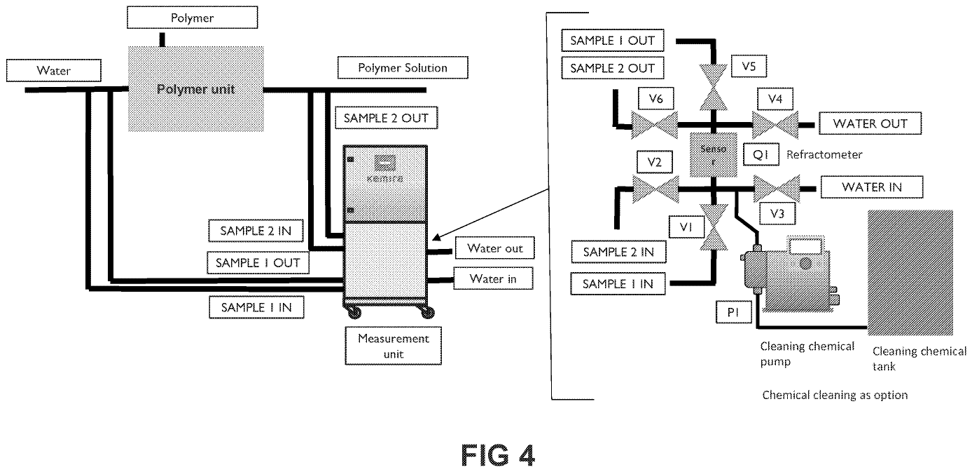

An additional application of refractometry include real-time monitoring of polymer hydration for industrial processes for treating tailings streams, for which one of many possible methods is shown in FIG. 3. Another application of the present invention includes real-time monitoring of polymer hydration with an integrated means for cleaning refractometers using a chemical cleaning pump, which is fed from a chemical tank, for which one of many possible methods is shown in FIG. 4. Any apparatus depicted in FIGS. 1-4 may be used to analyze the inversion of novel liquid emulsion polymer prior to use for enhanced oil recovery (EOR) or any other application for which inverted polymers are applied, wherein a concentrated liquid polymer must be inverted prior to use. In this case, refractometry may be used to determine extent of inversion, polymer concentration after inversion, and polymer viscosity after inversion.

### Example 2: Measurement of Polymer Concentration Using Refractometry

Evaluation of refractometry for determination of polymer concentration was carried out in a laboratory using a refractometer to measure refractive indices of polymer solutions.

### Polymer Solutions

Aqueous polymer solutions were prepared by dissolving low molecular weight (MW), low charge, hydrolyzed, non-sulfonated polyacrylamide polymer (Polymer 1, Table 1) in aqueous components consisting of synthetic brine or field water (Table 2). Another aqueous polymer solution was prepared by dissolving very high MW, high charge, hydrolyzed non-sulfonated polyacrylamide polymer (Polymer 2, Table 1) in synthetic brine (Table 2). A stock solution was prepared of each polymer at a concentration of 0.5 weight % by mixing in the polymer first at 400 rpm for 1 hour, followed by 250 rpm for 16 hours using an overhead mixer. To make test samples, the stock solution was diluted in the appropriate test liquid to obtain the correct final concentration and mixed gently for 30 min with a magnetic agitator prior to refractive index measurement. Final polymer concentration: 500, 800, 1000, 1500, 1800, 2000, and 2500 ppm.

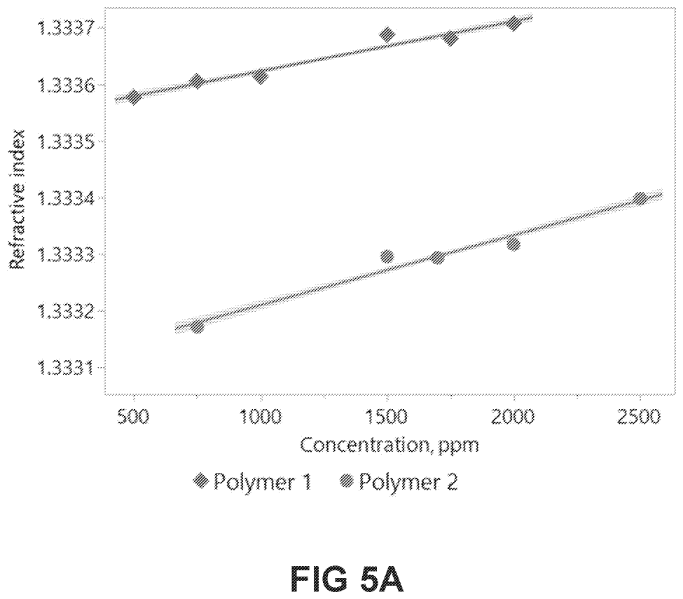

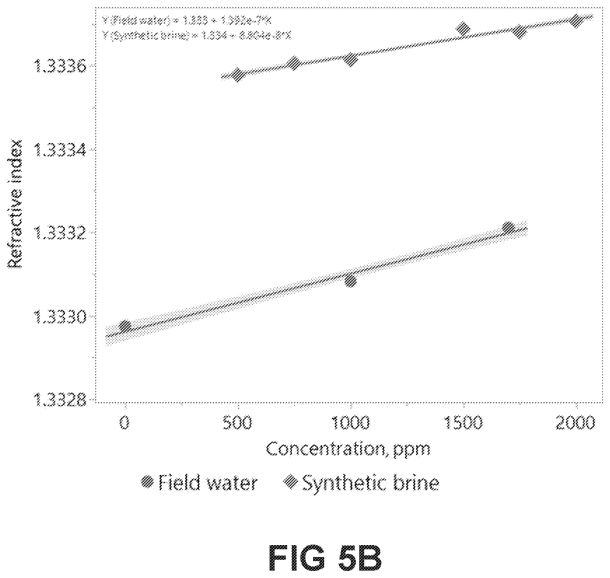

Synthetic brine and field water were used to calibrate a laboratory refractometer. The refractometer was then used to measure refractive indices of the polymer solutions. Refractive indices were used to a create a standard curve from which polymer concentration of other samples may be determined. Results are shown in FIGS. 5A-B.

A linear relationship between polymer concentration and refractive index was observed for all solutions. Solutions containing polymer 1 (low MW, low charge) have a higher baseline than solutions containing polymer 2 (very high MW, high charge) (FIG. 5A). These results indicate that relative polymer charge has an effect on the magnitude of refractive index (i.e., higher polymeric charge decreases the overall signal); however, the linearity of each curve and dynamic range (e.g., 500-2500 ppm) were unaffected by relative polymer charge.

A linear relationship between polymer concentration and refractive index was observed for solutions made from polymer 1 in synthetic brine and polymer 1 in field water (FIG. 5B). The baseline of polymer 1 in synthetic brine (TDS=2812 mg/kg, see Table 2) was higher than the baseline of the same polymer dissolved in field water (TDS=2424 mg/kg, see Table 2). These results indicate that relative amounts of dissolved solids (total dissolved solids, TDS) within the aqueous component also affects the magnitude of refractive index (i.e., higher TDS increases the overall signal); however, the linearity and dynamic range (e.g., 0-2000 ppm) of each curve were unaffected by TDS of the aqueous component.

These results provide initial proof of concept that refractometry can be used to monitor concentrations of two different polymers dissolved in two different types of brine, indicating a potential wide range of use for multiple industries. These results also illustrate the importance positioning at least two refractometers as shown in FIG. 1 to monitor in real-time both inlet feed of aqueous component and outlet feed of polymer mixture. In order to determine the concentration of a particular polymer by using the refractive index of the polymer solution, the baseline refractive index of the input liquid source must first be measured.

### Example 3: Measurement of Polymer Concentration Using Refractometry

Evaluation of refractometry for determination of polymer concentration was carried out in a laboratory using a refractometer to measure refractive indices of polymer solutions.

### Polymer Solutions

Aqueous polymer solutions were prepared by dissolving a high MW, low charge, hydrolyzed non-sulfonated polyacrylamide polymer (polymer 3, Table 2) in aqueous components consisting of synthetic brine 1 (TDS=23,635 mg/kg, Table 3) and synthetic brine 2 (TDS=2812 mg/kg, Table 3). A stock solution was prepared of each polymer at a concentration of 0.5 weight % by mixing in the polymer first at 400 rpm for 1 hour, followed by 250 rpm for 16 hours using an overhead mixer. To make test samples, the stock solution was diluted in the appropriate test liquid to obtain the correct final concentration and mixed gently for 30 min with a magnetic agitator prior to refractive index measurement. Final polymer concentration: 800, 1000, 1500, 1800, 2000, 2500, 3000, and 5000 ppm.

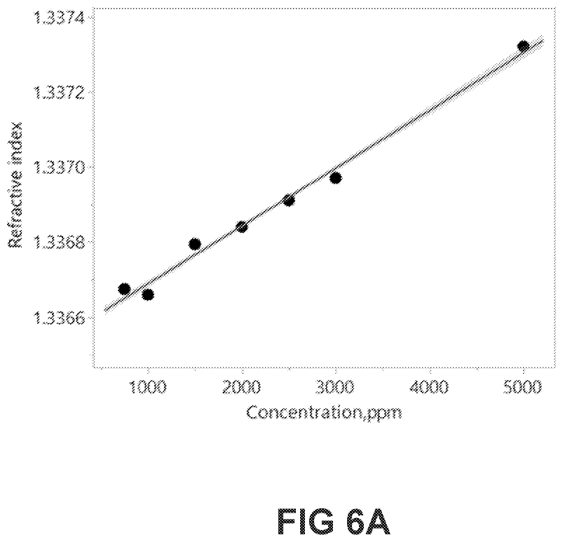

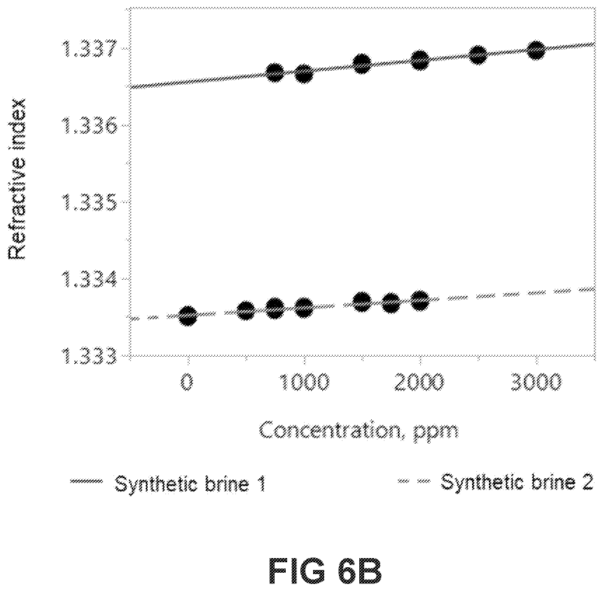

Synthetic brines 1 and 2 were used to calibrate a laboratory refractometer. The refractometer was then used to measure refractive indices of the polymer solutions. Refractive indices were used to a create a standard curve from which polymer concentration of other samples may be determined. Results are shown in FIGS. 6A-B.

A linear relationship between polymer concentration and refractive index was observed for polymer 3 dissolved in synthetic brine 1 (FIG. 6A). The linearity of this relationship is maintained when the polymer is dissolved in brine from different sources, as shown in FIG. 6B. The baseline of the refractive indices of the samples prepared using synthetic brine 1 (TDS=23635 mg/kg) is higher than that of the samples prepared using synthetic brine 2 (TDS=2812 mg/kg) (FIG. 6B). The baseline varies according to the total dissolved solids of the source water, but there is a linear relationship between concentration and refractive index for both sets of samples, and the slope of both lines is nearly the same.

These results indicate that relative amounts of dissolved solids (total dissolved solids, TDS) within the aqueous component also affects the magnitude of refractive index (i.e., higher TDS increases the overall signal); however, the linearity and dynamic range (e.g., 0-5000 ppm) of each curve were unaffected by TDS of the aqueous component.

Taken together with results from Example 2, these results provide further proof of concept that refractometry can be used to monitor concentrations of polymers dissolved in two different types of brine, indicating a potential wide range of use for multiple industries. These results also further illustrate the importance positioning at least two refractometers as shown in FIG. 1 to monitor in real-time both inlet feed of aqueous component and outlet feed of polymer mixture. In order to determine the concentration of a particular polymer by using the refractive index of the polymer solution, the baseline refractive index of the input liquid source must first be measured.

### Example 4: Measurement of Polymer Hydration and Viscosity Using Refractometry

Evaluation of refractometry for monitoring extent of polymer dissolution was carried out in a laboratory using a refractometer to measure refractive indices of polymer solutions. Viscosity was concurrently measured.

An aqueous polymer slurry was prepared by combining a polymer 4 (Table 1) for treatment of oil sands tailings with field water (Table 4) from an oil sand treatment process stream. Approximately 5 min later, the refractive index of the slurry was measured at ~20 min intervals over a 120 min time period while gently agitating the mixture. Viscosity measurements were recorded at the same time points using an Anton Paar rheometer at 23 °C. Results are shown in FIG. 7.

Results indicate that measurements of viscosity are highly correlated with measurements refractive index. These results provide proof of concept that refractive index can provide a real-time indication of the viscosity of a polymer solution during agitation. The measurements also indicate a dependence of both quantities on the hydration of the polymer over time. The majority of refractive index and viscosity signal increase was observed over the first 40 min of agitation, followed by asymptotic increase to a stable maximum.

What is claimed is:

1. A method for forming a hydrated polymer composition comprising an aqueous component and a polymer component comprising one or more polymers, which method comprises the monitoring of polymer content by refractometry during the method, the method comprising:
(a) measuring a first refractive index of the aqueous component with a refractometer, prior to addition of the polymer component;
(b) contacting an amount of said polymer component with said aqueous component optionally within a mixing tank or a feed pipe to create said hydrated polymer composition;
(c) measuring a second refractive index of said hydrated polymer composition, optionally after it is no longer in contact with the mixing tank or the feed pipe, with the refractometer used in the first refractive index measurement or a different refractometer; and
(d) optionally, measuring a third refractive index of said aqueous component and said polymer component within the mixing tank or feed pipe, with the refractometer used in the first and/or second refractive index measurements or a different refractometer;
wherein steps (a) to (c) or (a) to (d) are effected concurrently or successively, or in any order; and
(e) further optionally wherein one or more parameters of the method for forming the hydrated polymer composition (further optionally wherein said parameters include one or more of the feed rate of a reagent, polymer or polymer component, the feed rate of an aqueous component, the agitation rate, the agitation time, the temperature, the outlet feed rate, the total dissolved solids (TDS) of the aqueous component, the pH, the pressure, et al.), is/are adjusted based on the detected refractive indices.

2. The method of claim 1 wherein the polymer component comprises one or more of the following:
(a) an emulsion polymer comprising a dispersion of water, greater than about 10% by weight said one or more polymers, one or more emulsifier surfactants, and one or more inverting surfactants dispersed in one or more hydrophobic liquids having a boiling point at least about 100 °C, which emulsion polymer is inverted when contacted with said aqueous component to form said hydrated polymer composition;
(b) a dry polymer comprising said one or polymers formulated as granules, as a dry powder, or a combination thereof, further comprising a residual amount of water and optionally buffers, anti-caking additives, anti-dusting agents, and one or more surfactants to facilitate dissolution, which dry polymer is dissolved when contacted with said aqueous component to form said hydrated polymer composition; or
(c) an aqueous stock polymer solution comprising said one or more polymers dissolved in water at a concentration ranging from 500 to 800,000 ppm, 3000 to 100,000 ppm, 4000 to 40,000 ppm, 4000 to 10,000 ppm, from 4000 to 6000 ppm, or from 4500 to 5500 ppm, which aqueous stock polymer solution is diluted when contacted with said aqueous component to form said hydrated polymer composition.

3. The method of claim 2, wherein:
(a) the one or more emulsifier surfactants are selected from the group consisting of sorbitan esters, ethoxylated fatty alcohols with 1 to 4 ethyleneoxy groups, phthalic esters, fatty acid glycerides, glycerin esters, sorbitan monooleate, the reaction product of oleic acid with isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, and the ethoxylated versions of the foregoing containing 1 to 10 moles of ethylene oxide per mole of the basic emulsifier, modified polyester surfactants, anhydride substituted ethylene copolymers, N,N-dialkanol substituted fatty amides, tallow amine ethoxylates, and mixtures or combinations of the foregoing;
(b) the one or more inverting surfactants are selected from the group consisting of ethoxylated amine compounds, ethoxylated fatty acid compounds, and alkyl polyethyleneglycol ether carboxylic acid compounds, alkyl polyglycol ether carboxylic acid compounds, and salts or esters thereof, ethoxylated alcohols, alcohol ethoxylates, ethoxylated esters of sorbitan, ethoxylated esters of fatty acids, ethoxylated fatty acid esters, ethoxylated esters of sorbitol and fatty acids, nonionic surfactants comprising a hydrocarbon group and a polyalkylenoxy group of sufficient hydrophilic nature, nonionic surfactants of the general formula R1-O—(CH(R2)-CH2-O)nH (I), wherein R1 is a C8-C22-hydrocarbon group, n is a number of 2:4, and R2 is H, methyl or ethyl, and at least 50% of the groups R2 are H, polyethoxylates based on C10-C18-alcohols, tridecylalcohol ethoxylates comprising from 4 to 14 ethylenoxy groups, tridecyalcohol.8 EO, or C12/14 fatty alcohol ethoxylates, C12/14.8 EO, modified polyester surfactants, anhydride substituted ethylene copolymers, N,N-dialkanol substituted fatty amides, tallow amine ethoxylates, and mixtures and combinations of the forgoing; and
(c) the one or more hydrophobic liquids having a boiling point at least about 100 °C is selected from the group consisting of paraffin hydrocarbons, naphthene hydrocarbons, aromatic hydrocarbons, olefins, oils, stabilizing surfactants, and mixtures or combinations of the foregoing.

4. The method of any one of claims 1-3, wherein:
(a) said hydrated polymer composition is formed in a polymer mixing tank, in a polymer aging tank, in a polymer hydration unit, in a turbulent feed line or pipe, in a static feed line or pipe, in a polymer make down or make up unit, on-site, in a remote setting, or in an industrial or laboratory setting;
(b) said aqueous component comprises water, produced water, fresh water, salt water, brine, sea water, ground water, surface water, or reclaimed water, wastewater, municipal wastewater, industrial wastewater, paper or pulp wastewater, storm wastewater, mining tailings, oil sands tailings, sludge, papermaking whitewater, or a combination thereof;
(c) said one or more polymers comprise anionic, cationic, amphoteric, or non-ionic (neutral) polymers;
(d) said one or more polymers comprises one or more copolymers, terpolymers, linear polymers, branched polymers, cross-linked polymers, cationic polymers, anionic polymers, non-ionic polymers, grafted polymers, modified polymers, or any combination of the foregoing;
(e) said one or more polymers comprises one or more copolymers, terpolymers, linear polymers, branched polymers, cross-linked polymers, cationic polymers, anionic polymers, non-ionic polymers, grafted polymers, or modified polymers optionally selected from anionic, cationic or neutral polyacrylamide polymers and copolymers, including but not limited to, Acrylamide/Acrylic Acid copolymers, Acrylamide/acrylamido tertiary butyl sulfonic acid (ATBS aka AMPS) copolymers, Acrylamide/Acrylic Acid/ATBS terpolymer, Acrylamide/acryloyloxy ethyl trimethyl ammonium chloride (AETAC) cationic polyacrylamide copolymers, partially hydrolyzed acrylamide, or other acrylamide containing polymers, poly(ethylene oxide polymers), poly(propylene oxide polymers), polyacrylate polymers, a poly(maleic acid) polymers, poly(itaconic acid) polymers, poly(diallyldimethylammonium chloride) polymers, polyvinyl pyrrolidone polymers, polyvinyl alcohol polymers, poly(styrenic sulfonic acid) polymers, polyamine polymers and copolymers such as copolymers of dimethylamine and epichlorohydrin), polyamidoamine-epichlorohydrin copolymers, polyethyleneimine polymers, polyethylene glycols, cellulose and cellulose derivative comprising polymers such as carboxymethylcellulose (CMC), Methylcellulose (MC), ethylcellulose (EC), hydroxypropylcellulose (HPC), hydroxyethylcellulose (HEC), and hydroxypropylmethylcellulose (HPMC) polymers, carrageenans, agars, alginates, guar gums, locust bean gums, a gum tragacanth, a konjac glucomannan, a tara gum, a cassia gum, a gum arabic, a pectin, a starch, a xanthan gum, a gellan gum, a pullulan, a curdlan, a dextran, a welan gum, a rhamsan, a succinoglycan, cellulose gum, a modified starch, a propylene glycol alginate, modified guar gums, chitosans, polyphosphonates, and alfa and beta glucans, including but not limited to scleroglucan and schizophyllan;
(f) said polymer component comprises a plurality of different polymers;
(g) the molecular weight of said one or more polymers ranges from 500 Da to 200,000,000 Da, or from 10,000 Da to 100,000,000 Da, or from 10,000 Da to 50,000,000 Da or from 10,000 Da to 20,000,000 Da, or from 10,000 Da to 10,000,000 Da or from 10,000 Da to 1,000,000 Da or from 10,000 Da to 500,000 Da or from 10,000 Da to 100,000 Da;
(h) the concentration after mixing of said one or more polymers in said hydrated polymer composition is between 1 ppm and 800,000 ppm or between 1 and 300,000 ppm; or between 1 and 100,000 ppm; or between 1 and 20,000 ppm; or between 1 and 10,000 ppm; or between 1 and 1,000 ppm; or
(i) any combination of (a) to (h).

5. The method of any one of claims 1-4, wherein:
(a) said one or more polymers comprise an acrylamide-containing polymer comprising acrylamide, acrylic acid or any salt thereof, and optionally one or more additional cationic and/or anionic monomers;
(b) said one or more polymers comprise an acrylamide-containing polymer comprising acrylamide, acrylamido tertiary butyl sulfonic acid (ATBS) or any salt thereof, and optionally one or more additional cationic and/or anionic monomers; or
(c) said one or more polymers comprise an acrylamide-containing polymer comprising acrylamide, acrylic acid or any salt thereof, acrylamido tertiary butyl sulfonic acid (ATBS) or any salt thereof, and optionally one or more additional cationic and/or anionic monomers.

6. The method of any one of the foregoing claims, comprising one or more of the following:
(a) the method is effected continuously or periodically;
(b) the method is effected in an in-line manner on site, remotely on site, at a sampling point, or in a lab;
(c) there is a correlation between the second refractive index and a concentration of said one or more polymers in said hydrated polymer composition;
(d) there is a correlation between the second refractive index and a viscosity of said hydrated polymer composition;
(e) in (c) or (d) the correlation between the second refractive index and the concentration of said one or more polymers in said hydrated polymer composition is independent of the total dissolved solids (TDS) in mg/kg or the relative hardness in mol % of the aqueous component;
(f) said first, second, and third refractive indices are measured in real time;
(g) the results are electronically transmitted to another site, to a graphical user interface, to a controller, or to a feedback loop;
(h) said first refractive index is compared to said second refractive index or to said third refractive index to determine at least one property of said hydrated polymer composition; optionally wherein said at least one property comprises concentration, amount of hydration, a percent dissolution of said polymer, or combination thereof;
(i) said at least one property is determined more rapidly compared to an industrial analysis method comprising on-site sampling followed by laboratory analysis of concentration, viscosity, amount of hydration, or percent dissolution of said polymer;
(j) a first flow rate of said aqueous component or a second flow rate of said polymer component is adjusted based on the values of said first refractive index, said second refractive index and/or said third refractive index;
(k) said first refractive index and/or said second refractive index positively correlate with measurements of the viscosity of said aqueous component and/or said hydrated polymer composition;
(l) the hydrated polymer composition is optionally subjected to a secondary dilution step, wherein the secondary dilution step comprises addition of the hydrated polymer composition to a process water stream to form a second hydrated polymer composition;
(m) the hydrated polymer composition or the second hydrated polymer composition is used in an industrial application, including but not limited to, mining, petroleum extraction, enhanced oil recovery, oil sands processing, oil sands tailings treatment, paper or pulp manufacture, industrial water treatment, municipal water treatment, surface water treatment, storm water treatment, and agricultural waste treatment; or
(n) a combination of one or more of (a) to (m).

7. A method for forming a hydrated polymer composition comprising a first aqueous component and a polymer component comprising one or more polymers, which method comprises real-time monitoring of polymer content by refractometry during the method, the method comprising:
(a) measuring in real time a first refractive index of an aqueous inlet stream comprising the first aqueous component with a first refractometer, wherein said first refractive index is measured prior to contacting the first aqueous component with the polymer component;
(b) feeding said first aqueous inlet stream into a mixing tank or pipe at a first feed rate and feeding a polymer inlet stream comprising the polymer component into the mixing tank or pipe at a second feed rate;
(c) allowing the first aqueous component to contact the polymer component, thereby forming an initial hydrated polymer composition;
(d) agitating said initial hydrated polymer composition at an agitation rate for an agitation time;
(e) allowing the hydrated polymer composition to exit the mixing tank or pipe at an outlet rate as an outlet stream comprising the hydrated polymer composition and measuring in real time a second refractive index of the outlet stream with a second refractometer;
(f) optionally, measuring a third refractive index of the initial hydrated polymer composition in real time with a third refractometer, wherein said third refractometer is located inside the mixing tank or pipe and in contact with the initial hydrated polymer composition;
wherein steps (a)-(f) are effected concurrently, successively, or in any order; and
(g) further optionally wherein one or more parameters of the method for forming the hydrated polymer composition (further optionally wherein said parameters include one or more of the feed rate of a reagent, polymer or polymer component, the feed rate of an aqueous component, the agitation rate, the agitation time, the temperature, the outlet feed rate, the total dissolved solids (TDS) of the aqueous component, the pH, the pressure, et al.), is/are adjusted based on the detected refractive indices.

8. The method of claim 7 wherein the polymer component comprises one of the following:
(a) an emulsion polymer comprising a dispersion of water, greater than about 10% by weight said one or more polymers, one or more emulsifier surfactants, and one or more inverting surfactants dispersed in one or more hydrophobic liquids having a boiling point at least about 100 °C, which emulsion polymer is inverted when contacted with said aqueous component to form said hydrated polymer composition;
(b) a dry polymer comprising said one or polymers formulated as granules, as a dry powder, or a combination thereof, further comprising a residual amount of water and optionally buffers, anti-caking additives, anti-dusting agents, and one or more surfactants to facilitate dissolution, which dry polymer is dissolved when contacted with said aqueous component to form said hydrated polymer composition; or
(c) an aqueous stock polymer solution comprising said one or more polymers dissolved in water at a concentration ranging from 500 to 800,000 ppm, 3000 to 100,000 ppm, 4000 to 40,000 ppm, 4000 to 10,000 ppm, from 4000 to 6000 ppm, or from 4500 to 5500 ppm, which aqueous stock polymer solution is diluted when contacted with said aqueous component to form said hydrated polymer composition.

9. The method of claim 8, wherein:
(a) the one or more emulsifier surfactants are selected from the group consisting of sorbitan esters, ethoxylated fatty alcohols with 1 to 4 ethyleneoxy groups, phthalic esters, fatty acid glycerides, glycerin esters, sorbitan monooleate, the reaction product of oleic acid with isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, and the ethoxylated versions of the foregoing containing 1 to 10 moles of ethylene oxide per mole of the basic emulsifier, modified polyester surfactants, anhydride substituted ethylene copolymers, N,N-dialkanol substituted fatty amides, tallow amine ethoxylates, and mixtures or combinations of the foregoing;
(b) the one or more inverting surfactants are selected from the group consisting of ethoxylated amine compounds, ethoxylated fatty acid compounds, and alkyl polyethyleneglycol ether carboxylic acid compounds, alkyl polyglycol ether carboxylic acid compounds, and salts or esters thereof, ethoxylated alcohols, alcohol ethoxylates, ethoxylated esters of sorbitan, ethoxylated esters of fatty acids, ethoxylated fatty acid esters, ethoxylated esters of sorbitol and fatty acids, nonionic surfactants comprising a hydrocarbon group and a polyalkylenoxy group of sufficient hydrophilic nature, nonionic surfactants of the general formula R1-O—(CH(R2)-CH2-O)nH (I), wherein R1 is a C8-C22-hydrocarbon group, n is a number of 2:4, and R2 is H, methyl or ethyl, and at least 50% of the groups R2 are H, polyethoxylates based on C10-C18-alcohols, tridecylalcohol ethoxylates comprising from 4 to 14 ethylenoxy groups, tridecyalcohol.8 EO, or C12/14 fatty alcohol ethoxylates, C12/14.8 EO, modified polyester surfactants, anhydride substituted ethylene copolymers, N,N-dialkanol substituted fatty amides, tallow amine ethoxylates, and mixtures and combinations of the forgoing; and
(c) the one or more hydrophobic liquids having a boiling point at least about 100 °C is selected from the group consisting of paraffin hydrocarbons, naphthene hydrocarbons, aromatic hydrocarbons, olefins, oils, stabilizing surfactants, and mixtures or combinations of the foregoing.

10. The method of any one of claims 7-9, comprising one or more of the following:
(i) the first refractometer is positioned in contact with the first aqueous component prior to entering the mixing tank or pipe and the second refractometer is positioned in contact with the hydrated polymer composition after exiting the mixing tank or pipe;
(ii) a third refractive index of the initial hydrated polymer composition is measured in real time with a third refractometer, wherein said third refractometer is located inside the mixing tank or pipe and in contact with the initial hydrated polymer composition;
(iii) said first refractive index is used to determine a background signal and a real-time property of the inlet stream, including but not limited to, a total dissolved solids (TDS) in mg/kg and a relative hardness in mol %;
(iv) at least one of said real-time properties of the inlet stream is adjusted to remain within predetermined limits based on said first refractive index, optionally wherein said first aqueous component of said inlet stream is modified by addition of a second aqueous component to form a partially purified inlet stream based on any combination of said real-time properties of the inlet stream, wherein the TDS, total polymer concentration, relative hardness, and/or viscosity of the second aqueous component is less than the first aqueous component;
(v) said first refractive index is subtracted from said second refractive index to determine a real-time property of the outlet stream selected from the group of properties consisting of a total polymer concentration, a viscosity, an amount of polymer hydration, a percent of polymer dissolution, or any combination thereof;
(vi) a first parameter of mixing is adjusted based on any combination of said real-time properties of the outlet stream selected from the group of parameters consisting of the first feed rate, the second feed rate, the feed rate of said second aqueous component, the agitation rate, the agitation time, the temperature of the mixing tank or pipe, the outlet feed rate, the TDS of said first aqueous component, the pH, or any combination thereof;
(vii) said first refractive index is subtracted from said third refractive index to determine a real-time property of the initial hydrated polymer composition selected from the group of properties consisting of a total polymer concentration, a viscosity, an amount of polymer hydration, a percent of polymer dissolution, or any combination thereof;
(viii) a second parameter of mixing is adjusted based on any combination of said real-time properties of the initial hydrated polymer composition selected from the group of properties consisting of the first feed rate, the second feed rate, the agitation rate, the agitation time, the temperature of the mixing tank or pipe, the outlet feed rate, or any combination thereof;
(ix) if the first, second, and/or third refractive indices deviates from a predetermined upper or lower threshold an alarm is triggered and/or a corrective response is triggered to return the refractive index to within said predetermined upper or lower threshold;
(x) the mixing tank or pipe is heated or cooled based on said real-time property of the initial hydrated polymer composition, said real-time property of the outlet stream, or a combination thereof; or
(xi) any combination of (i) to (x).

11. The method of any one of claims 7-10, wherein:
(a) the method is effected continuously or periodically;
(b) the method is effected in a polymer hydration plant, in an on-site field application, or in a lab;
(c) said first aqueous inlet stream and said polymer inlet stream are added to the mixing tank or pipe simultaneously or separately;
(d) the mixing tank or pipe comprises a static tank, a feed pipe, a feed pipe with turbulent flow, a mechanical mixer, a static mixer, a magnetic agitator, a hydrodynamic mixer, a rocking tank, a hydraulic mixer, a polymer hydration unit, a polymer make down or make up unit, an agitator with mechanical stirrer, or any combination of the foregoing;
(e) the method is optionally run in an industrial or lab setting outside of a polymer hydration unit;
(f) said first refractive index, said second refractive index, said third refractive index, said real-time property of the inlet stream said real-time property of the initial hydrated polymer composition, and said real-time property of the outlet stream are measured periodically or continuously;
(g) said inlet stream, said first parameter of mixing, and/or said second parameter of mixing is modified once, periodically, or continuously;
(h) any or all of the refractometry results or real time properties are electronically transmitted to another site, to a graphical user interface, to a controller, and/or to a feedback loop;
(i) the method is run under pressure, wherein said pressure is greater than or equal to atmospheric pressure, further wherein said pressure ranges from 0.2 to 250 bar, or from 0.2 to 100 bar, or from 0.2 to 50 bar, or from 0.2 to 10-200 bar, or from 0.2 to 5 bar, typically 1-3 bar and more typically 1.5 to 2.0 bar; or
(j) any combination of (a)-(i).

12. The method of any one of claims 7-11, wherein:
(a) the first aqueous component comprises water, produced water, fresh water, salt water, brine, sea water, ground water, surface water, or reclaimed water, wastewater, municipal wastewater, industrial wastewater, paper or pulp wastewater, storm wastewater, mining tailings, oil sands tailings, sludge, papermaking whitewater, or a combination thereof;
(b) the first aqueous component comprises a total dissolved solids ranging from 0-500,000 mg/kg, or from 10-100,000 mg/kg, or from 10-50,000 mg/kg;
(c) the first aqueous component comprises a relative hardness ranging from 0.01-50 mol %, or from 0.1-10 mol %;
(d) said one or more polymers comprise one or more anionic, cationic, amphoteric, or non-ionic (neutral) polymers;
(e) said one or more polymers comprise one or more copolymers, terpolymers, linear polymers, branched polymers, cross-linked polymers, cationic polymers, anionic polymers, non-ionic polymers, grafted polymers, modified polymers, or any combination of the foregoing;
(f) said one or more polymers comprise one or more copolymers, terpolymers, linear polymers, branched polymers, cross-linked polymers, cationic polymers, anionic polymers, non-ionic polymers, grafted polymers, or modified polymers optionally selected from anionic, cationic or neutral polyacrylamide polymers and copolymers, including but not limited to, Acrylamide/Acrylic Acid copolymers, Acrylamide/acrylamido tertiary butyl sulfonic acid (ATBS aka AMPS) copolymers, Acrylamide/Acrylic Acid/ATBS terpolymers, Acrylamide/acryloyloxy ethyl trimethyl ammonium chloride (AETAC) cationic polyacrylamide copolymers, partially hydrolyzed acrylamide, or other acrylamide containing polymers, poly(ethylene oxide polymers), poly(propylene oxide polymers), polyacrylate polymers, a poly(maleic acid) polymers, poly(itaconic acid) polymers, poly(diallyldimethylammonium chloride) polymers, polyvinyl pyrrolidone polymers, polyvinyl alcohol polymers, poly(styrenic sulfonic acid) polymers, polyamine polymers and copolymers such as copolymers of dimethylamine and epichlorohydrin), polyamidoamine-epichlorohydrin copolymers, polyethyleneimine polymers, polyethylene glycols, cellulose and cellulose derivative comprising polymers such as carboxymethylcellulose (CMC), Methylcellulose (MC), ethylcellulose (EC), hydroxypropylcellulose (HPC), hydroxyethylcellulose (HEC), and hydroxypropylmethylcellulose (HPMC) polymers, carrageenans, agars, alginates, guar gums, locust bean gums, a gum tragacanth, a konjac glucomannan, a tara gum, a cassia gum, a gum arabic, a pectin, a starch, a xanthan gum, a gellan gum, a pullulan, a curdlan, a dextran, a welan gum, a rhamsan, a succinoglycan, cellulose gum, a modified starch, a propylene glycol alginate, modified guar gums, chitosans, polyphosphonates, and alfa and beta glucans, including but not limited to scleroglucan and schizophyllan;
(g) said polymer component comprises a plurality of different polymers;
(h) the molecular weight of said one or more polymers ranges from 500 Da to 200,000,000 Da, or from 10,000 Da to 100,000,000 Da, or from 10,000 Da to 50,000,000 Da or from 10,000 Da to 20,000,000 Da, or from 10,000 Da to 10,000,000 Da or from 10,000 Da to 1,000,000 Da or from 10,000 Da to 500,000 Da or from 10,000 Da to 100,000 Da; and
(i) the concentration after mixing of said one or more polymers in said hydrated polymer composition is between 1 ppm and 800,000 ppm or between 1 and 300,000 ppm; or between 1 and 100,000 ppm; or between 1 and 20,000 ppm; or between 1 and 10,000 ppm; or between 1 and 1,000 ppm; or
(j) any combination of (a) to (i).

13. The method of any one of claims 7-12, wherein:
(a) said one or more polymers comprise an acrylamide-containing polymer comprising acrylamide, acrylic acid or any salt thereof, and optionally one or more additional cationic and/or anionic monomers;
(b) said one or more polymers comprise an acrylamide-containing polymer comprising acrylamide, acrylamido tertiary butyl sulfonic acid (ATBS) or any salt thereof, and optionally one or more additional cationic and/or anionic monomers; or
(c) said one or more polymers comprise an acrylamide-containing polymer comprising acrylamide, acrylic acid or any salt thereof, acrylamido tertiary butyl sulfonic acid (ATBS) or any salt thereof, and optionally one or more additional cationic and/or anionic monomers.

14. The method of any one of claims 7-13, wherein:
(a) there is a positive correlation between said second refractive index and the amount of hydration of the polymer component in said hydrated polymer composition;
(b) there is a positive correlation between said second refractive index and the percent dissolution of the polymer component in said hydrated polymer composition;
(c) there is a positive correlation between said third refractive index and the amount of hydration of the polymer component in said initial hydrated polymer composition;
(d) there is a positive correlation between said third refractive index and the percent dissolution of the polymer component in said initial hydrated polymer composition;
(e) there is a correlation between said second refractive index and the final concentration of said polymer component in said hydrated polymer composition;
(f) there is a correlation between said second refractive index and the viscosity of said hydrated polymer composition;
(g) there is a correlation between said third refractive index and the concentration of said polymer component in said initial hydrated polymer composition;
(h) there is a correlation between said third refractive index and the viscosity of said initial hydrated polymer composition; or
(i) a combination of one or more of (a) to (h).

15. The method of any one of claims 7-14, wherein:
(a) the hydrated polymer composition is optionally subjected to a secondary dilution step, wherein the secondary dilution step comprises addition of the hydrated polymer composition to a process water stream to form a second hydrated polymer composition;
(b) the hydrated polymer composition or the second hydrated polymer composition is used in an industrial process relating to any phase of the oil sand mining processes, including but not limited to, recovery, extraction, refining, dewatering, and waste treatment; enhanced oil recovery, any mineral mining or mineral processing operation, sludge dewatering; pulp and papermaking, municipal wastewater treatment, oil and gas fracking, and any industrial process which requires polymer hydration or polymer inversion;
(c) said real-time property is determined more rapidly compared to an industrial analysis method comprising on-site sampling followed by laboratory analysis of concentration, viscosity, amount of hydration, or percent dissolution of said polymer; and/or
(d) said method optionally comprises on-site sampling of one or more of said aqueous inlet stream, said initial hydrated polymer composition, and said outlet stream followed by laboratory validation of said first refractive index, said second refractive index, and said third refractive index.
